(19) United States
(12) Patent Application Publication
(10) Pub. No.: US 2015/0326545 A1
(43) Pub. Date: Nov. 12, 2015

(54) SECURE KEY ROTATION FOR AN ISSUER SECURITY DOMAIN OF AN ELECTRONIC DEVICE

(71) Applicant: Apple Inc., Cupertino, CA (US)

(72) Inventor: Ahmer A. Khan, Cupertino, CA (US)

(21) Appl. No.: 14/475,241

(22) Filed: Sep. 2, 2014

Related U.S. Application Data
(60) Provisional application No. 61/989,137, filed on May 6, 2014.

(51) Int. Cl. H04L 29/06

(52) U.S. Cl. CPC H04L 63/0457; H04L 63/061; H04L 63/0823

(57) ABSTRACT

Systems, methods, and computer-readable media for securely rotating keys for an issuer security domain of an electronic device are provided. In one example embodiment, an electronic device may include a communications component that receives encrypted issuer data from a commercial entity subsystem. The electronic device may also include a secure element that, inter alia, decrypts the encrypted issuer data with a first key that is stored in an issuer security domain of the secure element and stores a second key in the issuer security domain based on the decrypted issuer data. Additional embodiments are also provided.

### CROSS-REFERENCE TO RELATED APPLICATION(S)

This application claims the benefit of prior filed U.S. Provisional Patent Application No. 61/989,137, filed May 6, 2014, which is hereby incorporated by reference herein in its entirety.

### TECHNICAL FIELD

This disclosure relates to the secure rotation of keys of an electronic device and, more particularly, to the secure rotation of keys for an issuer security domain of an electronic device.

### BACKGROUND OF THE DISCLOSURE

Portable electronic devices (e.g., cellular telephones) may be provided with near field communication (“NFC”) components for enabling contactless proximity-based communications with another entity. Often times, these communications are associated with financial transactions or other secure data transactions that require the electronic device to access and share a commerce credential, such as a credit card credential or a public transportation ticket credential, previously provisioned on the device. However, the provisioning of such commerce credentials on an electronic device is often insecure or inefficient.

### SUMMARY OF THE DISCLOSURE

This document describes systems, methods, and computer-readable media for securely rotating keys for an issuer security domain of an electronic device capable of near field communications and/or other wireless communications.

For example, a method may include storing a first key in an issuer security domain of an electronic device, establishing a first secure communication path between the issuer security domain and a commercial entity subsystem using the first key, receiving issuer data from the commercial entity subsystem at the issuer security domain via the first secure communication path, and storing a second key in the issuer security domain in response to the received issuer data.

As another example, an electronic device may be in communication with a commercial entity subsystem, and the electronic device may include a communications component that receives encrypted issuer data from the commercial entity subsystem, and a secure element that decrypts the encrypted issuer data with a first key that is stored in an issuer security domain of the secure element and that stores a second key in the issuer security domain based on the decrypted issuer data.

As yet another example, a method may include storing a first key in an issuer security domain of a secure element of an electronic device, receiving issuer data at the secure element from a commercial entity subsystem, decrypting the received issuer data with the stored first key at the secure element, and storing a second key in the issuer security domain based on the decrypted issuer data.

As yet another example, a commercial entity system may be in communication with an electronic device, and the commercial entity system may include at least one processor component, at least one memory component, and at least one communications component. The commercial entity system may encrypt issuer data with a first key and communicate the encrypted issuer data to an issuer security domain of the electronic device for generating a second key at the electronic device.

As yet another example, a non-transitory computer-readable medium may include computer-readable instructions recorded thereon for storing a first key in an issuer security domain of a secure element of an electronic device, decrypting issuer data with the stored first key at the secure element, and storing a second key in the issuer security domain based on the decrypted issuer data.

This Summary is provided merely to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for rotating keys of an issuer security domain of an electronic device;

FIG. 2 is a more detailed schematic view of the electronic device of the system of FIG. 1;

FIG. 3 is a front view of the electronic device of FIGS. 1 and 2;

FIG. 4 is another more detailed schematic view of the electronic device of FIGS. 1-3; and

FIGS. 5 and 6 are flowcharts of illustrative processes for rotating keys of an issuer security domain of an electronic device.

### DETAILED DESCRIPTION OF THE DISCLOSURE

A vendor ISD key may be stored in an issuer security domain (“ISD”) of a secure element of an electronic device, and such a vendor ISD key may also be accessible to a commercial entity subsystem as well as a secure element vendor subsystem that may have provided the vendor ISD key to the secure element. Initial data to be communicated between the secure element and the commercial entity subsystem may first be encrypted with the vendor ISD key, such that a secure communication channel may be created between the commercial entity subsystem and the secure element. However, in order to limit the possibility of the secure element vendor subsystem creating a similar secure communication channel between the secure element vendor subsystem and the secure element with the vendor ISD key, the commercial entity subsystem may utilize the initial data that may be communicated between the secure element and the commercial entity subsystem as encrypted with the vendor ISD key to instruct the secure element to generate and/or otherwise store an issuer ISD key in the issuer security domain of the secure element. Such an issuer ISD key may be shared with the commercial entity subsystem such that any additional data to be communicated between the secure element and the commercial entity subsystem (e.g., commerce credential data) may be encrypted with the issuer ISD key rather than with the vendor ISD key, such that a secure communication channel may be created between the commercial entity subsystem and the secure element, and such that the vendor ISD key may be deleted from the secure element to prevent the secure element vendor subsystem from creating a secure communication channel between the secure element vendor subsystem and the secure element.

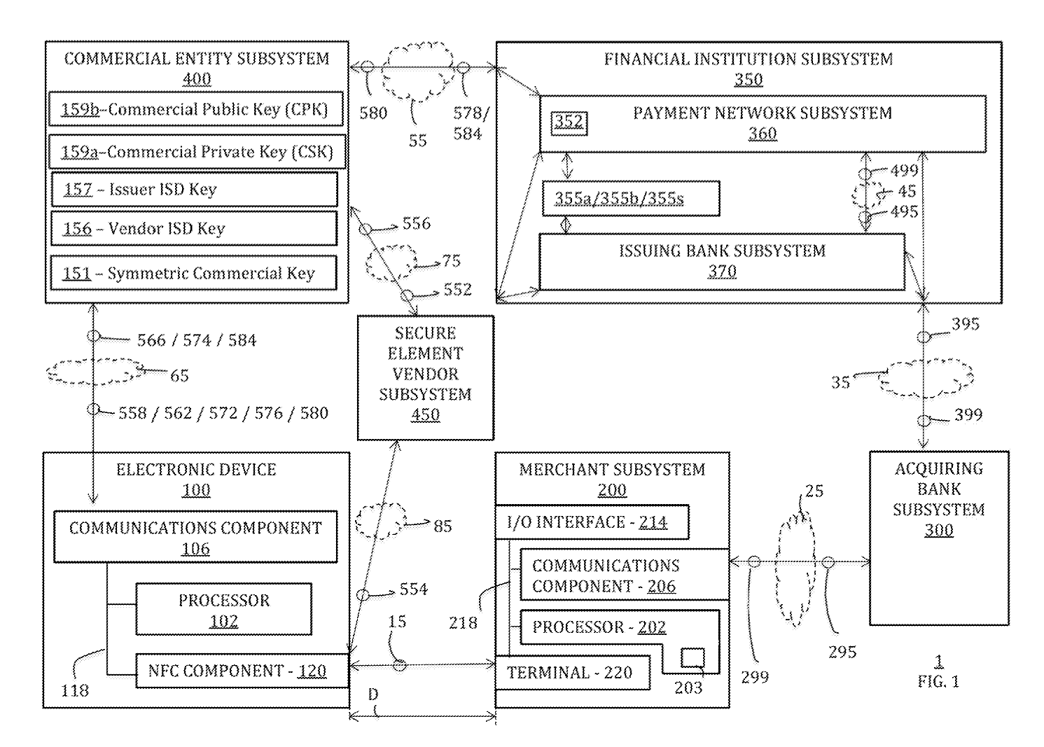

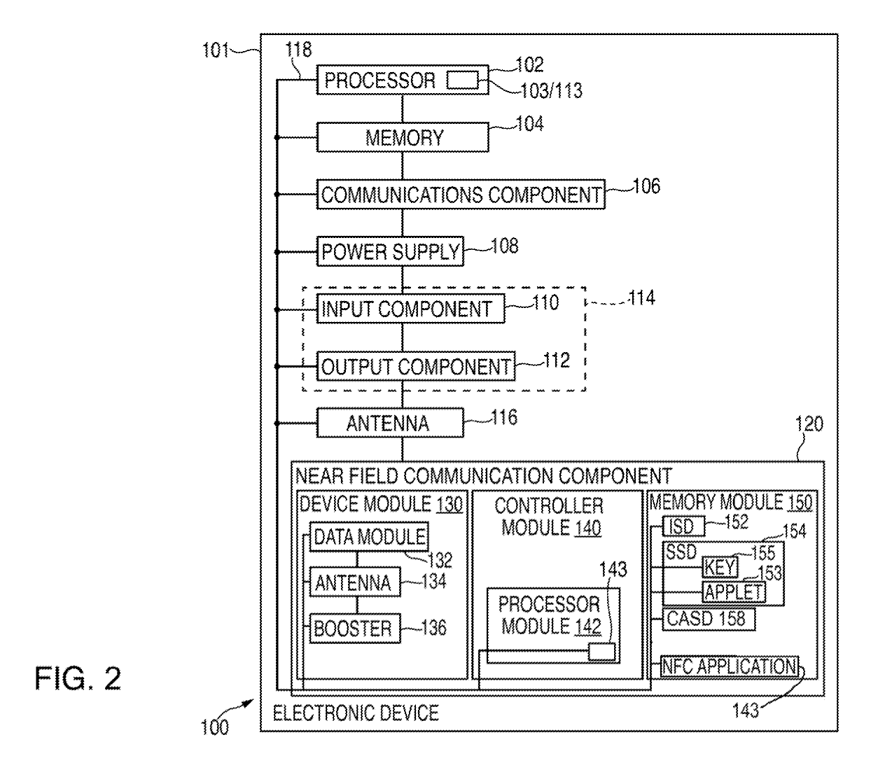

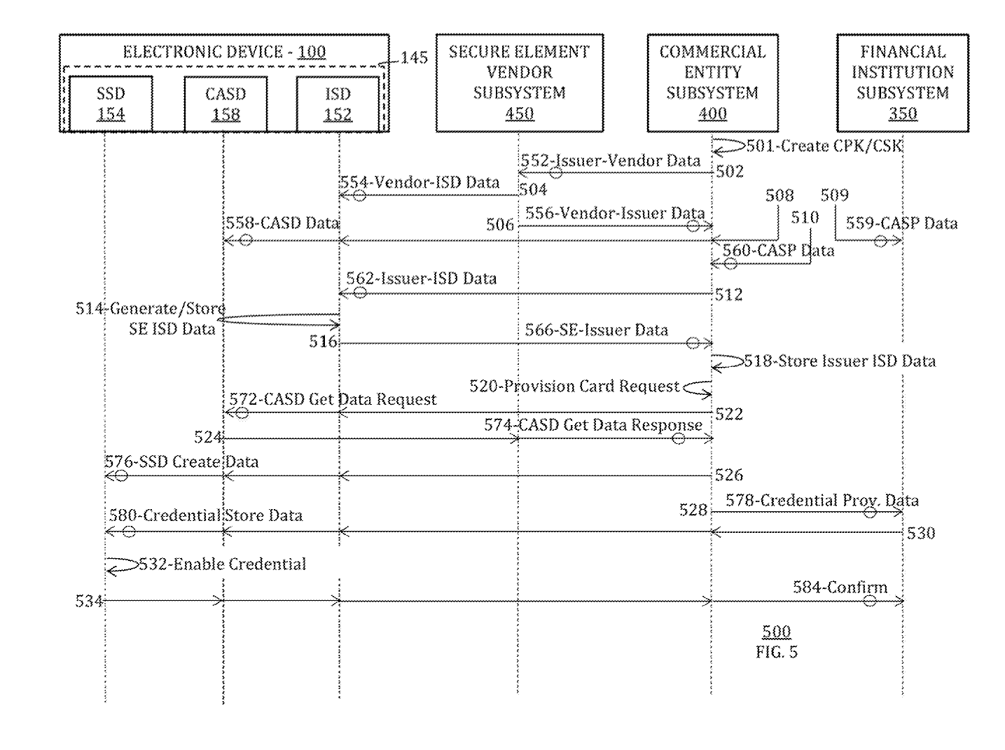

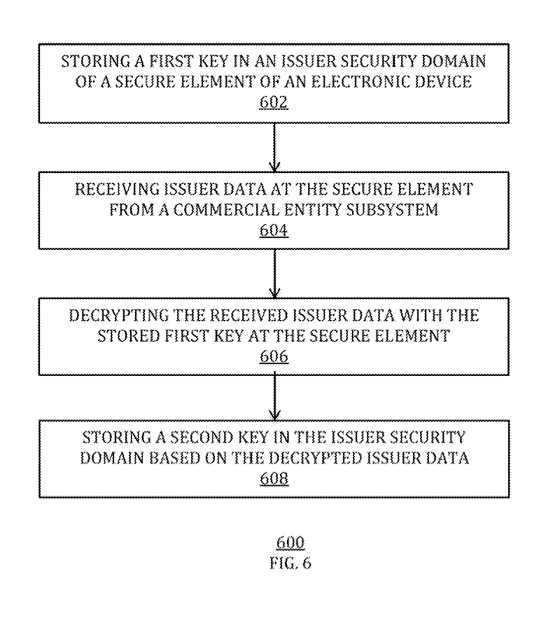

FIG. 1 shows a system 1 in which keys of an issuer security domain of an electronic device 100 may be rotated by a commercial entity subsystem 400 (e.g., in conjunction with a secure element vendor subsystem 450) to enable the secure provisioning of one or more credentials on electronic device 100 by a financial institution subsystem 350 (e.g., in conjunction with commercial entity subsystem 400), and in which such credentials may be used by electronic device 100 for conducting a commercial transaction with a merchant subsystem 200 and an associated acquiring bank subsystem 300. FIGS. 2-4 show further details with respect to particular embodiments of electronic device 100 of system 1, while FIGS. 5 and 6 are flowcharts of illustrative processes for rotating keys of an issuer security domain of electronic device 100 in the context of system 1.

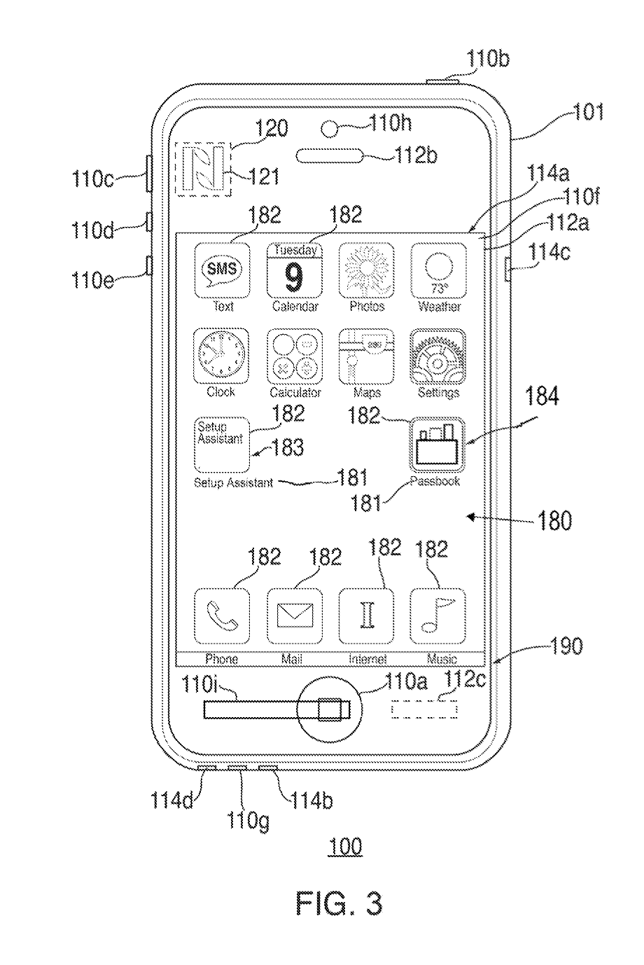

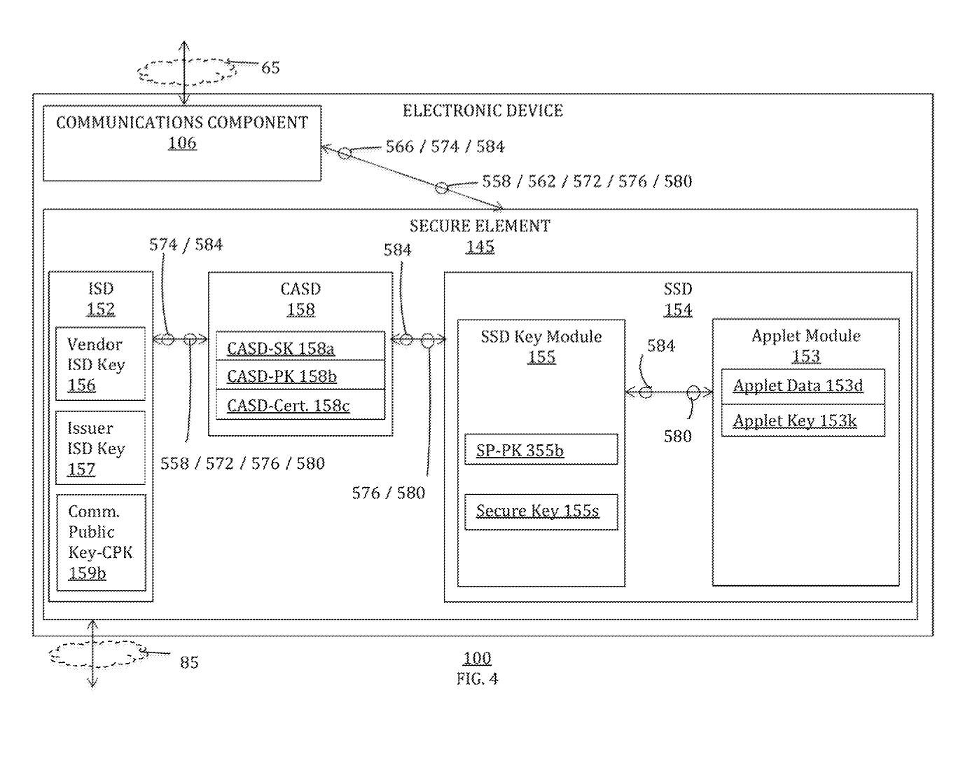

### Description of FIG. 1, FIG. 2. FIG. 3, and FIG. 4

FIG. 1 is a schematic view of an illustrative system 1 that may allow for the rotation of keys of an issuer security domain of an electronic device. For example, as shown in FIG. 1, system 1 may include an end-user electronic device 100 as well as a commercial entity subsystem 400 and a secure element vendor subsystem 450 for rotating keys of an issuer security domain of electronic device 100. Moreover, as shown in FIG. 1, system 1 may also include a financial institution subsystem 350 for securely provisioning credentials on electronic device 100 (e.g., via commercial entity subsystem 400). Moreover, as shown in FIG. 1, system 1 may also include a merchant subsystem 200 for receiving contactless proximity-based communications 15 (e.g., near field communications) from electronic device 100 based on such provisioned credentials, as well as an acquiring bank subsystem 300 that may utilize such contactless proximity-based communications 15 for completing a transaction with financial institution subsystem 350.

As shown in FIG. 2, and as described in more detail below, electronic device 100 may include a processor 102, memory 104, communications component 106, power supply 108, input component 110, output component 112, antenna 116, and near field communication (“NFC”) component 120, where input component 110 and output component 112 may sometimes be a single I/O component or I/O interface 114, such as a touch screen, that may receive input information through a user's touch of a display screen and that may also provide visual information to a user via that same display screen. Electronic device 100 may also include a bus 118 that may provide one or more wired or wireless communication links or paths for transferring data and/or power to, from, or between various other components of device 100. Electronic device 100 may also be provided with a housing 101 that may at least partially enclose one or more of the components of device 100 for protection from debris and other degrading forces external to device 100. Processor 102 may be used to run one or more applications, such as an application 103 and/or an application 113. Each one of applications 103 and 113 may include, but is not limited to, one or more operating system applications, firmware applications, media playback applications, media editing applications, communication applications, NFC applications, biometric feature-processing applications, or any other suitable applications. For example, processor 102 may load an application 103/113 as a user interface program to determine how instructions or data received via an input component 110 or other component of device 100 may manipulate the way in which information may be stored and/or provided to the user via an output component 112. As one example, application 103 may be an operating system application while application 113 may be a third party application (e.g., an application associated with a merchant of merchant subsystem 200 and/or an application associated with a financial institution of financial institution subsystem 350 and/or an application generated and/or maintained by commercial entity subsystem 400).

NFC component 120 may be any suitable proximity-based communication mechanism that may enable any suitable contactless proximity-based transactions or communications 15 between electronic device 100 and merchant subsystem 200 (e.g., a merchant payment terminal 220 of merchant subsystem 200). NFC component 120 may include any suitable modules for enabling contactless proximity-based communication 15 between electronic device 100 and subsystem 200. As shown in FIG. 2, for example, NFC component 120 may include an NFC device module 130, an NFC controller module 140, and an NFC memory module 150. NFC device module 130 may include an NFC data module 132, an NFC antenna 134, and an NFC booster 136. NFC controller module 140 may include at least one NFC processor module 142 that may be used to run one or more applications, such as an NFC low power mode application or wallet application or cryptography application 143 that may help dictate a function of NFC component 120. NFC memory module 150 may operate in conjunction with NFC device module 130 and/or NFC controller module 140 to allow for NFC communication 15 between electronic device 100 and merchant subsystem 200. NFC memory module 150 may be tamper resistant and may provide at least a portion of a secure element 145 (see, e.g., FIG. 4). For example, such a secure element 145 may be configured to provide a tamper-resistant platform (e.g., as a single or multiple chip secure microcontroller) that may be capable of securely hosting applications and their confidential and cryptographic data (e.g., applets 153 and keys 155) in accordance with rules and/or security requirements that may be set forth by a set of well-identified trusted authorities (e.g., an authority of financial institution subsystem 350 and/or an industry standard, such as GlobalPlatform).

As shown in FIGS. 2 and 4, NFC memory module 150 may include one or more of an issuer security domain (“ISD”) 152, a supplemental security domain (“SSD”) 154 (e.g., a service provider security domain (“SPSD”), a trusted service manager security domain (“TSMSD”), etc.), and a controlling authority security domain (“CASD”) 158, one or more of which may be defined and managed by an NFC specification standard (e.g., GlobalPlatform). For example, ISD 152 may be a portion of NFC memory module 150 in which a trusted service manager (“TSM”) or issuing financial institution (e.g., commercial entity subsystem 400 and/or financial institution subsystem 350) may store keys and/or other suitable information for creating or otherwise provisioning one or more credentials (e.g., commerce credentials associated with various credit cards, bank cards, gift cards, access cards, transit passes, etc.) on electronic device 100 (e.g., via communications component 106), for credential content management, and/or for security domain management. As shown in FIG. 4, for example, and as described in more detail below with respect to FIG. 5, ISD 152 may include one or more ISD keys (e.g., vendor ISD key(s) 156 and/or issuer ISD key(s) 157) that may also be known to a trusted service manager associated with that security domain (e.g., commercial entity subsystem 400, as shown in FIG. 1).

A specific supplemental security domain (“SSD”) 154 may be associated with a particular TSM (e.g., a particular financial institution subsystem 350) and at least one specific commerce credential (e.g., a specific credit card credential or a specific public transit card credential) that may provide specific privileges or payment rights to electronic device 100. Each SSD 154 may have its own SSD key module 155 and at least one of its own credential applications or credential applets or applet modules 153 (e.g., a Java card applet instance) associated with a particular commerce credential. As shown in FIG. 4, for example, and as described in more detail below with respect to FIG. 5, SSD key module 155 may be configured to include and/or may be configured to generate at least one SSD secure key 155s. Moreover, as shown in FIG. 4, for example, and as described in more detail below with respect to FIG. 5, a credential applet 153 may have its own applet key for its own applet data (e.g., applet key 153k for credential applet data 153d), where a credential applet 153 may need to be activated to enable its associated commerce credential for use by NFC device module 130 as an NFC communication 15 between electronic device 100 and merchant subsystem 200. Multiple applets 153 may be provided on one SSD 154 and/or multiple SSDs 154 may be provided on NFC memory module 150.

CASD 158 may be a special purpose security domain that may be configured to serve as a third-party on-element root of trust. An associated application may be configured to provide on-element confidential key generation as a global service to other applications and to a specific management layer (e.g., a GlobalPlatform management layer). The confidential key material that may be used within CASD 158 may be configured such that it cannot be inspected or modified by any entity, including an issuer of secure element 145. As shown in FIG. 4, for example, and as described in more detail below with respect to FIG. 5, CASD 158 may be configured to include and/or may be configured to generate a CASD private key (“CASD-SK”) 158a, a CASD public key (“CASD-PK”) 158b, and/or a CASD certificate (“CASD-Cert.”) 158c.

As shown in FIG. 3, and as described below in more detail, a specific example of electronic device 100 may be a handheld electronic device, such as an iPhone™, where housing 101 may allow access to various input components 110a-110i, various output components 112a-112c, and various I/O components 114a-114d through which device 100 and a user and/or an ambient environment may interface with each other. For example, a touch screen I/O component 114a may include a display output component 112a and an associated touch input component 110f, where display output component 112a may be used to display a visual or graphic user interface (“GUI”) 180, which may allow a user to interact with electronic device 100. GUI 180 may include various layers, windows, screens, templates, elements, menus, and/or other components of a currently running application (e.g., application 103 and/or application 113 and/or application 143) that may be displayed in all or some of the areas of display output component 112a. For example, as shown in FIG. 3, GUI 180 may be configured to display a first screen 190 with one or more graphical elements or icons 182 of GUI 180. When a specific icon 182 is selected, device 100 may be configured to open a new application associated with that icon 182 and display a corresponding screen of GUI 180 associated with that application. For example, when the specific icon 182 labeled with a “Setup Assistant” textual indicator 181 (i.e., specific icon 183) is selected, device 100 may launch or otherwise access a specific setup application and may display screens of a specific user interface that may include one or more tools or features for interacting with device 100 in a specific manner according to that application. As another example, when the specific icon 182 labeled with a “Passbook” textual indicator 181 (i.e., specific icon 184) is selected, device 100 may launch or otherwise access a specific “Passbook” or “wallet” application and may display screens of a specific user interface that may include one or more tools or features for interacting with device 100 in a specific manner according to that application.

Referring back to system 1 of FIG. 1, merchant subsystem 200 may include a reader or terminal 220 for detecting, reading, or otherwise receiving NFC communication 15 from electronic device 100 (e.g., when electronic device 100 comes within a certain distance or proximity D of terminal 220). Accordingly, it is noted that NFC communication 15 between merchant terminal 220 and electronic device 100 may occur wirelessly and, as such, may not require a clear “line of sight” between the respective devices. NFC device module 130 may be passive or active. When passive, NFC device module 130 may only be activated when within a response range D of a suitable terminal 220 of merchant subsystem 200. For instance, terminal 220 of merchant subsystem 200 may emit a relatively low-power radio wave field that may be used to power an antenna utilized by NFC device module 130 (e.g., shared antenna 116 or NFC-specific antenna 134) and, thereby, enable that antenna to transmit suitable NFC communication information (e.g., credit card credential information, such as may be provided by applet data 153d of an activated/enabled applet 153) via NFC data module 132, via antenna 116 or antenna 134, to terminal 220 of merchant subsystem 200 as NFC communication 15. When active, NFC device module 130 may incorporate or otherwise have access to a power source local to electronic device 100 (e.g., power supply 108) that may enable shared antenna 116 or NFC-specific antenna 134 to actively transmit suitable NFC communication information (e.g., credit card credential information, such as may be provided by applet data 153d of an activated/enabled applet 153) via NFC data module 132, via antenna 116 or antenna 134, to terminal 220 of merchant subsystem 200 as NFC communication 15, rather than reflect radio frequency signals, as in the case of a passive NFC device module 130. As also shown in FIG. 1, and as described below in more detail, merchant subsystem 200 may also include a merchant processor component 202 that may be the same as or similar to a processor component 102 of electronic device 100, a merchant application 203 that may be the same as or similar to an application 103/113 of electronic device 100, a merchant communications component 206 that may be the same as or similar to a communications component 106 of electronic device 100, a merchant I/O interface 214 that may be the same as or similar to an I/O interface 114 of electronic device 100, a merchant bus 218 that may be the same as or similar to a bus 118 of electronic device 100, a merchant memory component (not shown) that may be the same as or similar to a memory component 104 of electronic device 100, and/or a merchant power supply component (not shown) that may be the same as or similar to a power supply component 108 of electronic device 100.

When NFC component 120 is appropriately enabled and activated to communicate NFC communication 15 to merchant subsystem 200 with commerce credential data associated with an enabled credential of device 100 (e.g., commerce credential data, such as may be provided by applet data 153d of an activated/enabled applet 153 of SSD 154 of NFC component 120), acquiring bank subsystem 300 may utilize such commerce credential data of NFC communication 15 for completing a commercial or financial transaction with financial institution subsystem 350. Financial institution subsystem 350 may include a payment network subsystem 360 (e.g., a payment card association or a credit card association) and/or an issuing bank subsystem 370. For example, issuing bank subsystem 370 may be a financial institution that assumes primary liability for a consumer's capacity to pay off debts they incur with a specific credential. Each specific credential may be associated with a specific payment card that may be electronically linked to an account or accounts of a particular user. Various types of payment cards may be suitable, including credit cards, debit cards, charge cards, stored-value cards, fleet cards, gift cards, and the like. The commerce credential of a specific payment card may be provisioned on electronic device 100 by issuing bank subsystem 370 for use in an NFC communication 15 with merchant subsystem 200. Each credential may be a specific brand of payment card that may be branded by a payment network subsystem 360. Payment network subsystem 360 may be a network of various issuing banks 370 and/or various acquiring banks that may process the use of payment cards (e.g., commerce credentials) of a specific brand. Alternatively or additionally, certain credentials that may be provisioned on device 100 for use in a commercial or financial transaction may be electronically linked to or otherwise associated with an account or accounts of a particular user, but not associated with any payment card. For example, a bank account or other financial account of a user may be associated with a credential provisioned on device 100 but may not be associated with any payment card.

Payment network subsystem 360 and issuing bank subsystem 370 may be a single entity or separate entities. For example, American Express may be both a payment network subsystem 360 and an issuing bank subsystem 370. In contrast, Visa and MasterCard may be payment network subsystems 360, and may work in cooperation with issuing bank subsystems 370, such as Chase, Wells Fargo, Bank of America, and the like. Financial institution subsystem 350 may also include one or more acquiring banks, such as acquiring bank subsystem 300. For example, acquiring bank subsystem 300 may be the same entity as issuing bank subsystem 370. One, some, or all components of payment network subsystem 360 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of issuing bank subsystem 370 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

To facilitate transactions within system 1, one or more commerce credentials may be provisioned on electronic device 100. As shown in FIG. 1, commercial entity subsystem 400 may be provided within system 1, where commercial entity subsystem 400 may be configured to provide a new layer of security and/or to provide a more seamless user experience when it is being determined whether or not to provision a credential from financial institution subsystem 350 on device 100. Commercial entity subsystem 400 may be provided by a specific commercial entity that may offer various services to a user of device 100. As just one example, commercial entity subsystem 400 may be provided by Apple Inc. of Cupertino, Calif., which may also be a provider of various services to users of device 100 (e.g., the iTunes™ Store for selling/renting media to be played by device 100, the Apple App Store™ for selling/renting applications for use on device 100, the Apple iCloud™ Service for storing data from device 100, the Apple Online Store for buying various Apple products online, etc.), and which may also be a provider, manufacturer, and/or developer of device 100 itself (e.g., when device 100 is an iPod™, iPad™, iPhone™, or the like). Additionally or alternatively, commercial entity subsystem 400 may be provided by a network operator (e.g., a mobile network operator, such as Verizon or AT&T, which may have a relationship with a user of device 100 (e.g., as a provider of a data plan for enabling the communication of data over a certain communication path and/or using a certain communication protocol with device 100)).

The commercial entity that may provide, manage, or at least partially control commercial entity subsystem 400 may also provide different users with their own personalized accounts for using the services offered by that commercial entity. Each user account with the commercial entity may be associated with a specific personalized user ID and password that a user may use to log-in to their account with the commercial entity. Each user account with the commercial entity may also be associated with or have access to at least one commerce credential that can then be used by the user for purchasing services or products offered by the commercial entity. For example, each Apple ID user account may be associated with at least one credit card of a user associated with that Apple ID, such that the credit card may then be used by the user of that Apple ID account for procuring services from Apple's iTunes™ Store, the Apple App Store™, the Apple iCloud™ Service, and the like. The commercial entity that may provide, manage, or at least partially control commercial entity subsystem 400 (e.g., Apple Inc.) may be distinct and independent from any financial entity of financial institution subsystem 350. For example, the commercial entity that may provide, manage, or at least partially control commercial entity subsystem 400 may be distinct and independent from any payment network subsystem 360 or issuing bank subsystem 370 that may furnish and/or manage any credit card or other commerce credential associated with a user account of the commercial entity. Similarly, the commercial entity that may provide, manage, or at least partially control commercial entity subsystem 400 may be distinct and independent from any payment network subsystem 360 or issuing bank subsystem 370 that may furnish and/or manage any commerce credential to be provisioned on user device 100. Such a commercial entity may leverage the known commerce credential information associated with each of its user accounts and/or any suitable information that commercial entity subsystem 400 may determine about device 100 in order to more securely determine with commercial entity subsystem 400 whether a specific credential offered by financial institution subsystem 350 ought to be provisioned on a user device 100 or removed therefrom. Additionally or alternatively, such a commercial entity may leverage its ability to configure or control various components of device 100 (e.g., software and/or hardware components of device 100 when that commercial entity at least partially produces or manages device 100) in order to provide a more seamless user experience for a user of device 100 when he or she wants to provision a credential offered by financial institution subsystem 350 on device 100 or remove a credential therefrom.

Commercial entity subsystem 400 may be a secure platform system and, although not shown in FIG. 1, may include a secure mobile platform (“SMP”) broker component, an SMP trusted services manager (“TSM”) component, an SMP crypto services component, an identity management system (“IDMS”) component, a fraud system component, a hardware security module (“HSM”) component, and/or a store component, as described in more detail below. One, some, or all components of commercial entity subsystem 400 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of commercial entity subsystem 400 may be managed by, owned by, at least partially controlled by, and/or otherwise provided by a single commercial entity (e.g., Apple Inc.) that may be distinct and independent from financial institution subsystem 350. The components of commercial entity subsystem 400 may interact with each other and collectively with both financial institution subsystem 350 and electronic device 100 for providing a new layer of security and/or for providing a more seamless user experience when provisioning credentials on device 100.

A third-party vendor may generate at least a portion of a secure element that may be provisioned on electronic device 100. As shown in FIG. 1, secure element vendor subsystem 450 may be provided within system 1, where secure element vendor subsystem 450 may be configured to fabricate at least a portion of secure element 145 that may later be embedded or otherwise included as a part of electronic device 100 (e.g., by a manufacturer of the majority of device 100, such as Apple Inc.). Secure element vendor subsystem 450 may be provided by a specific vendor entity that may offer various services and/or products to a manufacturer of device 100. As just one example, secure element vendor subsystem 450 may be provided NXP Semiconductors of Eindhoven, Netherlands. Secure element vendor subsystem 450 may be a secure platform system and, although not shown in FIG. 1, may include a secure mobile platform (“SMP”) broker component, an SMP trusted services manager (“TSM”) component, an SMP crypto services component, an identity management system (“IDMS”) component, a fraud system component, a hardware security module (“HSM”) component, and/or a store component, as described in more detail below. One, some, or all components of secure element vendor subsystem 450 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of secure element vendor subsystem 450 may be managed by, owned by, at least partially controlled by, and/or otherwise provided by a single vendor entity (e.g., NXP Semiconductor) that may be distinct and/or independent from an entity that may manage, own, control, and/or otherwise provide commercial entity subsystem 400 (e.g., Apple Inc.). Additionally or alternatively, one, some, or all components of secure element vendor subsystem 450 may be managed by, owned by, at least partially controlled by, and/or otherwise provided by a single vendor entity that may be distinct and/or independent from an entity that may manage, own, control, and/or otherwise provide financial institution subsystem 350. The components of secure element vendor subsystem 450 may interact with each other and collectively with both commercial entity subsystem 400 and electronic device 100 for preparing at least a portion of secure element 145 for use on electronic device 100.

### Description of FIG. 5

FIG. 5 is a flowchart of an illustrative process 500 for rotating keys of an issuer security domain of an electronic device. Process 500 is shown being implemented by the various elements of system 1 of FIGS. 1-4 (e.g., electronic device 100, financial institution subsystem 350, commercial entity subsystem 400, and secure element vendor subsystem 450). However, it is to be understood that process 500 may be implemented using any other suitable components or subsystems.

Process 500 may begin at step 502, where issuer-vendor data 552 may be provided to secure element vendor subsystem 450. For example, issuer-vendor data 552 may be used by secure element vendor subsystem 450 for initially configuring a secure element to be used by electronic device 100. As shown, issuer-vendor data 552 may be provided to secure element vendor subsystem 450 (e.g., to an HSM component of secure element vendor subsystem 450) by commercial entity subsystem 400. Issuer-vendor data 552 may include any suitable data that may be generated by commercial entity subsystem 400 and/or by any other suitable entity, and then used by secure element vendor subsystem 450 in order to generate initial ISD keys (e.g., vendor ISD key 156, as described below). For example, issuer-vendor data 552 may include any suitable symmetrical key, such as an Advanced Encryption Standard (“AES”) 128 bit key, a Shamir's Secret Sharing (“SSS”) key, master keys (e.g., master transport keys), key derivation functions (“KDFs”), or any other suitable key (i.e., symmetric commercial key 151 of FIG. 1) or associated elements. Such issuer-vendor data 552 may be utilized by secure element vendor subsystem 450 for initially configuring secure element 145 with vendor ISD key(s) that may be used to create an initial secure communication channel with secure element 145. Such issuer-vendor data 552 may also remain accessible to commercial entity subsystem 400 (e.g., a copy of symmetric commercial key 151 may be stored on or otherwise accessed by commercial entity subsystem 400, as shown in FIG. 1). Commercial entity subsystem 400 may be considered a secure element issuer trusted service manager (“SEI-TSM”), and such issuer-vendor data 552 may be provided by commercial entity subsystem 400 to secure element vendor subsystem 450 via a communications path 75 of FIG. 1. For example, as shown in FIG. 1, a communications component of commercial entity subsystem 400 may be configured to communicate such issuer-vendor data 552 (e.g., symmetric commercial key 151) with a communications component of secure element vendor subsystem 450 using any suitable communications protocol over any suitable communications path 75.

Next, at step 504, issuer-vendor data 552 may be utilized by secure element vendor subsystem 450 to generate and transmit vendor-ISD data 554 to secure element 145 (e.g., to ISD 152). For example, as shown in FIGS. 1 and 4, one or more vendor ISD keys 156 may be stored in secure element 145 (e.g., in ISD 152 by secure element vendor subsystem 450) by at least a portion of vendor-ISD data 554, where such vendor ISD key(s) 156 may be utilized by a remote entity (e.g., commercial entity subsystem 400) to create a secure communication channel with secure element 145. Vendor-ISD data 554 may be generated in any suitable way by secure element vendor subsystem 450. For example, secure element vendor subsystem 450 may be configured to utilize any suitable key derivation function (“KDF”) available to secure element vendor subsystem 450 to generate at least one vendor ISD key 156 (e.g., as vendor-ISD data 554) from issuer-vendor data 552 (e.g., from symmetric commercial key 151) and from a unique identifier (e.g., an SEID) for the particular secure element being populated (i.e., secure element 145). Such vendor-ISD data 554 may be provided by secure element vendor subsystem 450 to secure element 145 via a communications path 85 of FIGS. 1 and 4. For example, any suitable communications component of secure element vendor subsystem 450 may be configured to communicate such vendor-ISD data 554 with secure element 145 using any suitable communications protocol over any suitable communications path 85.

Such vendor ISD key(s) 156 may also remain accessible or otherwise available to commercial entity subsystem 400 (e.g., a copy of vendor ISD key(s) 156 may be stored on, generated by, and/or otherwise accessed by commercial entity subsystem 400, as shown in FIG. 1). For example, at step 506, which may occur before, at least partially during, and/or after step 504 of process 500, vendor-issuer data 556 may be transmitted by secure element vendor subsystem 450 to commercial entity subsystem 400 for enabling commercial entity subsystem 400 to obtain vendor ISD key(s) 156. Vendor-issuer data 556 may include the unique identifier for the particular secure element being populated (i.e., secure element 145) as may have been used by the KDF of secure element vendor subsystem 450 at step 504, such that, when using the same KDF on the secure element unique identifier of received data 556 and issuer-vendor data 552 (e.g., symmetric commercial key 151) local to commercial entity subsystem 400, commercial entity subsystem 400 may be able to generate the same vendor ISD key(s) 156 of vendor-ISD data 554. Such vendor-issuer data 556 may be provided by secure element vendor subsystem 450 to commercial entity subsystem 400 via a communications path 75 of FIG. 1. For example, as shown in FIG. 1, a communications component of secure element vendor subsystem 450 may be configured to communicate such vendor-issuer data 556 with a communications component of commercial entity subsystem 400 (e.g., an HSM, in factory or otherwise) using any suitable communications protocol over any suitable communications path 75 (e.g., manually or automatically).

Therefore, vendor ISD key(s) 156 may be stored on secure element 145 as well as accessible to commercial entity subsystem 400. Vendor ISD key(s) 156 may be private and known to secure element 145 (e.g., ISD 152) and commercial entity subsystem 400 but may not be publicly accessible by other components or entities. In such embodiments, any future data to be communicated between secure element 145 and commercial entity subsystem 400 may first be encrypted with vendor ISD key(s) 156, such that a secure communication channel may be created between commercial entity subsystem 400 and secure element 145 and/or such that the encrypted data may not be accessible by any entity that is not privy to vendor ISD key(s) 156 (e.g., any entity other than secure element 145 and commercial entity subsystem 400). For example, it may be desirable for vendor ISD key(s) 156 not to be accessible to secure element vendor subsystem 450 so that secure element vendor subsystem 450 may not be able to create a secure communication channel with secure element 145 once secure element 145 is provided on electronic device 100 (e.g., as may be sold to an end user). That is, after secure element vendor subsystem 450 may generate and/or transmit vendor-ISD data 554 to secure element 145, secure element vendor subsystem 450 may delete or otherwise not maintain a record of vendor-ISD data 554 and/or the ability to regenerate such vendor-ISD data 554 (e.g., secure element vendor subsystem 450 may not maintain issuer-vendor data 552 after step 504). However, if secure element vendor subsystem 450 were to maintain (e.g., surreptitiously) the ability to access vendor-ISD data 554 for enabling creation of a secure communication channel with secure element 145, it may be beneficial to generate new ISD key(s) that may be known by both secure element 145 and commercial entity subsystem 400 but not by secure element vendor subsystem 450.

Process 500 may also include step 508, where controlling authority security domain (“CASD”) data 558 may be provided on an electronic device. For example, CASD 158, which may be configured to include and/or may be configured to generate CASD private key (“CASD-SK”) 158a, CASD public key (“CASD-PK”) 158b, and/or CASD certificate (“CASD-Cert.”) 158c, may be provided on secure element 145 of NFC component 120 of electronic device 100 by at least a portion of CASD data 558. CASD 158 may be utilized by NFC component 120 as a special purpose security domain that may be configured to serve as a third-party on-element root of trust, and an associated application (e.g., CASD Certificate 158c) may be configured to provide on-element confidential key generation as a global service to other applications and to a specific management layer (e.g., a GlobalPlatform management layer). The confidential key material that may be used within CASD 158 may be configured such that CASD 158 cannot be inspected or modified by certain entities, including an issuer of secure element 145 (e.g., commercial entity subsystem 400). For example, CASD data 558 may be introduced into secure element 145 by a trustable third party (not shown), such as any suitable controlling authority (“CA”), where CASD 158 provided by CASD data 558 may be configured to conform to the specifications of any suitable standard (e.g., “GlobalPlatform's Card Specification Version 2.2,” which is hereby incorporated by reference herein in its entirety). CASD 158 may be configured to provide a service provider's security domain (“SPSD”) on secure element 145 with an independent service interface, which may include certificate authentication, signature, data decryption, and the like. For example, as described below, SSD 154 may be an SPSD that may be controlled or otherwise managed by financial institution subsystem 350 as a service provider of SSD 154, such that financial institution subsystem 350 may be considered a service provider trusted service manager (“SP-TSM”) for that SSD 154.

CASD data 558 may be provisioned on secure element 145 at step 508 before or after secure element 145 may be provisioned on device 100. Additionally or alternatively, CASD data 558 may be provisioned on secure element 145 at step 508 before, at least partially concurrently with, or after vendor-ISD data 554 may be provisioned on secure element 145 at step 504. In some embodiments, CASD data 558 may be provisioned on secure element 145 of device 100 via commercial entity subsystem 400, where CASD data 558 may first be encrypted with vendor ISD key(s) 156 and/or with issuer ISD key(s) 157 by commercial entity subsystem 400, such that the encrypted CASD data 558 may not be accessible by any entity that is not privy to such ISD key(s) (e.g., any entity other than ISD 152 and commercial entity subsystem 400). In such embodiments, CASD data 558 may be provided by commercial entity subsystem 400 to electronic device 100 via communications path 65 of FIG. 1. For example, as shown in FIG. 4, communications component 106 of electronic device 100 may be configured to receive such CASD data 558 via commercial entity subsystem 400 using any suitable communications protocol over any suitable communications path 65, where encrypted CASD data 558 may be provided to ISD 152, decrypted with vendor ISD key(s) 156 and/or with issuer ISD key(s) 157, and then stored on secure element 145 as CASD 158.

Similarly, process 500 may also include step 509, where at least a portion of CASD data 558 and/or any other suitable CA data may be provided to financial institution subsystem 350 as controlling authority service provider (“CASP”) data 559. For example, like CASD data 558, CASP data 559 may be configured to include and/or may be configured to generate a CASP private key (“CASP-SK”), a CASP public key (“CASP-PK”), and/or a CASP certificate (“CASP-Cert.”) at financial institution subsystem 350. CASP data 559 may be introduced into financial institution subsystem 350 at step 509 by a trustable third party (not shown), such as any suitable controlling authority (“CA”), which may be the same as the party that introduced CASD data 558 into secure element 145 at step 508. CASP data 559 may be introduced into financial institution subsystem 350 at step 509 before or after secure element 145 may be provisioned on device 100. Additionally or alternatively, CASP data 559 may be introduced into financial institution subsystem 350 at step 509 before, at least partially concurrently with, or after CASD data 558 may be provisioned on secure element 145 at step 508. CASP data 559 may be configured to conform to the specifications of any suitable standard (e.g., “GlobalPlatform's Card Specification Version 2.2,” which is hereby incorporated by reference herein in its entirety). CASP data 559 may be utilized by financial institution subsystem 350 to enable financial institution subsystem 350 to authenticate, sign, unsign, encode, decode, encrypt, and/or decrypt any data to be communicated between financial institution subsystem 350 and secure element 145 of electronic device 100, whereas CASD data 558 may be similarly utilized by secure element 145 of electronic device 100 to enable electronic device 100 to authenticate, sign, encrypt, and/or decrypt any data to be communicated between financial institution subsystem 350 and secure element 145 of electronic device 100, such that the communicated data between secure element 145 and financial institution subsystem 350 may be protected from abuse by commercial entity subsystem 400 or any other entity that may be relied on as a conduit for such communicated data.

Additionally or alternatively, process 500 may also include step 510, where at least a portion of CASD data 558 and/or any other suitable CA data may be provided to commercial entity subsystem 400 as controlling authority service provider (“CASP”) data 560. For example, like CASD data 558, CASP data 560 may be configured to include and/or may be configured to generate a CASP private key (“CASP-SK”), a CASP public key (“CASP-PK”), and/or a CASP certificate (“CASP-Cert.”) at commercial entity subsystem 400. CASP data 560 may be introduced into commercial entity subsystem 400 at step 510 by a trustable third party (not shown), such as any suitable controlling authority (“CA”), which may be the same as the party that introduced CASD data 558 into secure element 145 at step 508. CASP data 560 may be introduced into commercial entity subsystem 400 at step 510 before or after secure element 145 may be provisioned on device 100. Additionally or alternatively, CASP data 560 may be introduced into commercial entity subsystem 400 at step 510 before, at least partially concurrently with, or after CASD data 558 may be provisioned on secure element 145 at step 508. CASP data 560 may be configured to conform to the specifications of any suitable standard (e.g., “GlobalPlatform's Card Specification Version 2.2,” which is hereby incorporated by reference herein in its entirety). CASP data 560 may be utilized by commercial entity subsystem 400 to enable commercial entity subsystem 400 to authenticate, sign, unsign, encode, decode, encrypt, and/or decrypt any data to be communicated between commercial entity subsystem 400 and secure element 145 of electronic device 100, whereas CASD data 558 may be similarly utilized by secure element 145 of electronic device 100 to enable electronic device 100 to authenticate, sign, encrypt, and/or decrypt any data to be communicated between commercial entity subsystem 400 and secure element 145 of electronic device 100, such that the communicated data between secure element 145 and commercial entity subsystem 400 may be protected from abuse by secure element vendor subsystem 450 or any other entity that may be otherwise privy to vendor ISD key(s) 156.

At step 512, commercial entity subsystem 400 may generate and transmit issuer-ISD data 562 to secure element 145 in order to change the key(s) of ISD 152 from vendor ISD key(s) 156 to a new ISD key or a new set of ISD keys (i.e., issuer ISD key(s) 157) that may not be known by or accessible to secure element vendor subsystem 450. However, until such new issuer ISD key(s) 157 have been setup, a secure communication channel for communication between commercial entity subsystem 400 and secure element 145 may be created using vendor ISD key(s) 156. Therefore, at step 512, issuer-ISD data 562 may be communicated to secure element 145 of device 100 by commercial entity subsystem 400, where such issuer-ISD data 562 may first be encrypted with vendor ISD key(s) 156 by commercial entity subsystem 400, such that the encrypted issuer-ISD data 562 may not be accessible by any entity that is not privy to vendor ISD key(s) 156 (e.g., any entity other than secure element 145, commercial entity subsystem 400, and, possibly, secure element vendor subsystem 450). Encrypted issuer-ISD data 562 may be provided by commercial entity subsystem 400 to electronic device 100 via communications path 65 of FIG. 1. For example, as shown in FIG. 4, communications component 106 of electronic device 100 may be configured to receive such encrypted issuer-ISD data 562 via commercial entity subsystem 400 using any suitable communications protocol over any suitable communications path 65, where encrypted issuer-ISD data 562 may be provided to ISD 152 of secure element 145, decrypted with vendor ISD key(s) 156 of secure element 145, and then processed by secure element 145. In response to receiving issuer-ISD data 562, secure element 145 (e.g., ISD 152 and/or CASD 158) may be configured to decrypt and process issuer-ISD data 562 at step 514 for creating new issuer ISD key(s) 157 and then to transmit SE-issuer data 566 to commercial entity subsystem 400 at step 516 for sharing new issuer ISD key(s) 157 with commercial entity subsystem 400.

Issuer-ISD data 562 may be generated and/or transmitted by commercial entity subsystem 400 at step 512 to include any suitable data that may instruct and/or enable secure element 145 to setup new issuer ISD key(s) 157. Secure element 145 may be configured to receive and process issuer-ISD data 562 at step 514 in any suitable way such that secure element 145 may generate and store new issuer ISD key(s) 157 on secure element 145 (e.g., in ISD 152, as shown in FIG. 4). New issuer ISD key(s) 157 may overwrite old vendor ISD key(s) 156 on secure element 145 such that vendor ISD key(s) 156 may be deleted or otherwise disabled on secure element 145 and such that vendor ISD key(s) 156 may not be used by secure element 145 going forward (e.g., after step 514, such that secure element vendor subsystem 450 may not be able to securely communicate with secure element 145 even if secure element vendor subsystem 450 has maintained vendor ISD key(s) 156). Secure element 145 may also be configured to transmit SE-issuer data 566 to commercial entity subsystem 400 at step 516, where SE-issuer data 566 may be any suitable data for sharing new issuer ISD key(s) 157 with commercial entity subsystem 400 or for otherwise making new issuer ISD key(s) 157 accessible to commercial entity subsystem 400. In some embodiments, secure element 145 may use vendor ISD key(s) 156 for encrypting SE-issuer data 566 before transmitting SE-issuer data 566 to commercial entity subsystem 400 at step 516, such that a secure communication channel may exist between secure element 145 and commercial entity subsystem 400 for step 516. Alternatively, a public/private key set may be generated by or for commercial entity subsystem 400 and the public key may be provided to secure element 145, such that secure element 145 may use that public key for encrypting SE-issuer data 566 before transmitting SE-issuer data 566 to commercial entity subsystem 400, such that a secure communication channel may exist between secure element 145 and commercial entity subsystem 400 for step 516. For example, at step 501, commercial entity subsystem 400 may generate commercial private key (“CSK”) 159a and commercial public key (“CPK”) 159b of any suitable type in any suitable way. Both CSK 159a and CPK 159b may be stored or otherwise accessible to commercial entity subsystem 400, as shown in FIG. 1. Moreover, CPK 159b may be provided on secure element 145 for use at step 516 (e.g., for encrypting SE-issuer data 566 with CPK 159b), as shown in FIG. 4. In some embodiments, CPK 159b may be provided by commercial entity 400 to secure element vendor subsystem 450 (e.g., at step 502 as part of issuer-vendor data 552) and then CPK 159b may be provided by secure element vendor subsystem 450 to secure element 145 (e.g., at step 504 as part of vendor-ISD data 554). Alternatively or additionally, CPK 159b may be provided by commercial entity subsystem 400 to secure element 145 directly (e.g., at step 512 as part of issuer-ISD data 562). Therefore, once issuer ISD key(s) 157 have been generated at step 514, secure element 145 may be configured to encrypt SE-issuer data 566 with CPK 159b and then transmit encrypted SE-issuer data 566 to commercial entity subsystem 400 at step 516, where SE-issuer data 566 may be any suitable data for sharing new issuer ISD key(s) 157 with commercial entity subsystem 400. At step 518, commercial entity subsystem 400 may receive encrypted SE-issuer data 566, decrypt encrypted SE-issuer data 566 (e.g., with CSK 159a), and then process decrypted SE-issuer data 566 to access and store new issuer ISD key(s) 157 at commercial entity subsystem 400, as shown in FIG. 1. Then, going forward (e.g., at step 522 described below), a secure communication channel may be established between commercial entity subsystem 400 and secure element 145 using new issuer ISD key(s) 157, rather than using vendor ISD key(s) 156 (e.g., as at step 512) and/or rather than using CPK 159b (e.g., as at step 516). New issuer ISD key(s) 157 may overwrite old vendor ISD key(s) 156 on commercial entity subsystem 400 such that vendor ISD key(s) 156 may be deleted or otherwise disabled on commercial entity subsystem 400 and such that vendor ISD key(s) 156 may not be used by commercial entity subsystem 400 going forward (e.g., after step 518). Any suitable push or pull model may be used to provide new issuer ISD key(s) 157 on secure element 145, including an ECC pull method, an RSA pull method, an ECC push method, and an RSA push method, where the keys may be generated by commercial entity subsystem 400, then encrypted, and then pushed into secure element 145.

Issuer ISD key(s) 157 of any suitable type may be generated in any suitable way. In some embodiments, a Rivest-Shamir-Adleman (“RSA”) Pull Model may be leveraged by secure element 145 for onboard key generation of issuer ISD key(s) 157 in a substantially similar fashion to that described with respect to key generation for supplemental security domains in “GlobalPlatform Card, Confidential Card Content Management, Card Specification, Version 2.2, Amendment A, Version 1.0.1, January 2011,” which is hereby incorporated by reference herein in its entirety.

Alternatively, an Elliptic Curve Cryptography (“ECC”) Pull Model may be leveraged by secure element 145 and commercial entity subsystem 400 for key generation of issuer ISD key(s) 157 in a substantially similar fashion to that described with respect to key generation for supplemental security domains in co-pending U.S. Provisional Patent Application No. 61/932,526, filed on Jan. 28, 2014 and titled “SECURE PROVISIONING OF CREDENTIALS ON AN ELECTRONIC DEVICE USING ELLIPTIC CURVE CRYPTOGRAPHY,” which is hereby incorporated by reference herein in its entirety.

Alternatively, as yet another example, an Elliptic Curve Cryptography (“ECC”) Push Model may be leveraged by secure element 145 and commercial entity subsystem 400 for key generation of issuer ISD key(s) 157 in a substantially similar fashion to that described with respect to key generation for supplemental security domains in “GlobalPlatform Card, Security Upgrade for Card Content Management, Card Specification, Version 2.2, Amendment E, Version 1.0, November 2011,” which is hereby incorporated by reference herein in its entirety.

Once issuer ISD key(s) 157 have been provided to both secure element 145 and commercial entity subsystem 400 (e.g., after step 518), a secure communication channel may be established between commercial entity subsystem 400 and secure element 145 using new issuer ISD key(s) 157 for communications between commercial entity subsystem 400 and secure element 145 (e.g., for provisioning a credential on secure element 145). For example, at step 520, process 500 may include system 1 receiving a request to provision a commerce credential on electronic device 100, where step 520 may include commercial entity subsystem 400 receiving any suitable request for a particular commerce credential to be provisioned on device 100 (e.g., a request initiated by a user of device 100 via interaction with an application of device 100 (e.g., through user interaction with GUI 180 on I/O interface 114a of device 100, such as during use of a setup assistant application associated with “Setup Assistant” icon 183 and/or during use of a “Passbook” or “Wallet” application associated with “Passbook” icon 184 of FIG. 3), a request initiated by commercial entity subsystem 400 itself, and/or a request generated by financial institution subsystem 350). Such a request of credential provisioning may include any suitable identification information associated with the selected credential that may be used by commercial entity subsystem 400 and/or financial institution subsystem 350 for provisioning that credential onto device 100 (e.g., a hashed or true listing of at least a portion of a primary account number (“PAN”) for the selected credential, the card verification value (“CVV”) for the selected credential, the expiration date for the selected credential, the billing address for the selected credential, the service provider (e.g., bank or payment network responsible for the credential), etc.). Moreover, such a request may include any other suitable information that may be useful for enabling the provisioning of the selected credential on device 100 (e.g., information associated with the target device 100, such as an SSD identifier, which may be indicative of an available SSD 154 of NFC component 120 of device 100 that may be able to receive such a provisioned credential).

In order to properly provision a commerce credential on secure element 145 using elliptic curve cryptography, for example, process 500 may share certain CASD data regarding CASD 158 of electronic device 100 with the service provider of that commerce credential (i.e., financial institution subsystem 350). In some embodiments, financial institution subsystem 350 may receive such CASD data directly from a controlling authority or otherwise as at least a portion of CASP data 559 at step 509. Alternatively or additionally, in response to receiving a request to provision a particular commerce credential on a particular electronic device 100 (e.g., at step 520), system 1 (e.g., commercial entity subsystem 400) may be configured to generate and transmit a CASD “Get Data” request or command 572 to that particular electronic device 100 at step 522 in order to retrieve certain CASD data that may then be shared with the particular service provider for that particular commerce credential (i.e., service provider financial institution subsystem 350). In such instances, CASD Get Data request 572 may be generated and transmitted at step 522 to the electronic device 100 that may be identified in the credential provisioning request of step S204, where CASD Get Data request 572 may be a command that may attempt to retrieve at least a portion of the data from CASD 158 of secure element 145 (e.g., CASD 158 as may have been provisioned on secure element 145 at step 508). For example, CASD Get Data request 572 may include a request for CASD-SK 158a, CASD-PK 158b, and/or CASD-Cert. 158c of CASD 158 of secure element 145.

As mentioned, such a CASD Get Data request 572 may be communicated to secure element 145 of device 100 by commercial entity subsystem 400, where such a CASD Get Data request 572 may first be encrypted with issuer ISD key(s) 157 by commercial entity subsystem 400, such that the encrypted CASD Get Data request 572 may not be accessible by any entity that is not privy to issuer ISD key(s) 157 (e.g., any entity other than secure element 145 and commercial entity subsystem 400). In such embodiments, CASD Get Data request 572 may be provided by commercial entity subsystem 400 to electronic device 100 via communications path 65 of FIG. 1. For example, as shown in FIG. 4, communications component 106 of electronic device 100 may be configured to receive such an encrypted CASD Get Data request 572 via commercial entity subsystem 400 using any suitable communications protocol over any suitable communications path 65, where encrypted CASD Get Data request 572 may be provided to ISD 152, decrypted with issuer ISD key(s) 157, and then forwarded to CASD 158 for handling. In response to receiving CASD Get Data request 572, secure element 145 (e.g., CASD 158) may be configured to process CASD Get Data request 572 and then generate and transmit a CASD “Get Data” response 574 to commercial entity subsystem 400 at step 524. For example, in response to receiving CASD Get Data request 572, CASD 158 may generate and transmit a CASD Get Data response 574 that may include CASD-Cert. 158c or any other suitable information from CASD 158 to commercial entity subsystem 400 at step 524. Such a CASD Get Data response 574 may be communicated to commercial entity subsystem 400 by device 100, where such a CASD Get Data response 574 may first be encrypted with issuer ISD key(s) 157 by ISD 152 of secure element 145 of device 100, such that the encrypted CASD Get Data response 574 may not be accessible by any entity that is not privy to issuer ISD key(s) 157 (e.g., any entity other than ISD 152 and commercial entity subsystem 400). In such embodiments, CASD Get Data response 574 may be provided by electronic device 100 to commercial entity subsystem 400 via communications path 65 of FIG. 1. For example, as shown in FIG. 4, communications component 106 of electronic device 100 may be configured to transmit such an encrypted CASD Get Data response 574 to commercial entity subsystem 400 using any suitable communications protocol over any suitable communications path 65, where encrypted CASD Get Data response 574 may be provided to commercial entity subsystem 400 and then decrypted with issuer ISD key(s) 157 of commercial entity subsystem 400.

Moreover, in response to receiving such a request to provision a commerce credential on electronic device 100 at step 520, at least a portion of an SSD may be created by commercial entity subsystem 400 (e.g., by an SMP broker component of commercial entity subsystem 400) and such an SSD (e.g., SSD 154) may be initially installed or otherwise provided on secure element 145 at step 526 through the transmission of SSD creation data 576 to secure element 145 by commercial entity subsystem 400. For example, an identifier for an SSD of device 100 (e.g., an SSD 154 of NFC component 120) into which the requested credential can be provisioned may be identified at step 526, where the SSD may be at least partially determined based on the secure element information that may be provided by the provisioning request of step 520. As mentioned, such SSD creation data 576 may be communicated to secure element 145 of device 100 by commercial entity subsystem 400, where such SSD creation data 576 may first be encrypted with issuer ISD key(s) 157 by commercial entity subsystem 400, such that the encrypted SSD creation data 576 may not be accessible by any entity that is not privy to issuer ISD key(s) 157 (e.g., any entity other than ISD 152 and commercial entity subsystem 400). In such embodiments, SSD creation data 576 may be provided by commercial entity subsystem 400 to electronic device 100 via communications path 65 of FIG. 1. For example, as shown in FIG. 4, communications component 106 of electronic device 100 may be configured to receive such encrypted SSD creation data 576 via commercial entity subsystem 400 using any suitable communications protocol over any suitable communications path 65, where encrypted SSD creation data 576 may be provided to ISD 152, decrypted with issuer ISD key(s) 157, and then forwarded to SSD 154 for initial handling.

Next, commercial entity subsystem 400 (e.g., an SMP broker component of commercial entity subsystem 400) may be configured to send a request to financial institution subsystem 350 for the provisioning on device 100 of the credential requested at step 520 (e.g., using any suitable communications protocol over any suitable communications path 55 (e.g., via a TSM of path 55)). For example, at step 528 of process 500 of FIG. 5, commercial entity subsystem 400 may be configured to generate and transmit credential provisioning data 578 to financial institution subsystem 350 (e.g., to a payment network subsystem 360 of financial institution subsystem 350) identified as the service provider or manager of the commerce credential to be provisioned. Such credential provisioning data 578 may include any suitable data or combination of data that may be utilized by service provider financial institution subsystem 350 to initiate the provisioning of a requested commerce credential onto secure element 145, such as data indicative of the selected credential that may be identified by the request at step 520 and/or data indicative of an SSD 154 of device 100 available for receiving the provisioned credential (e.g., data that may be included in SSD create data 576 of step 526). Alternatively or additionally, credential provisioning data 578 may include any suitable data indicative of CASD 158 provisioned on secure element 145. For example, credential provisioning data 578 may include any suitable CASD data of CASD Get Data response 574 that may have been received by commercial entity subsystem 400 at step 524 (e.g., CASD-Cert. 158c). By sharing certain CASD data with service provider financial institution subsystem 350, commercial entity subsystem 400 may enable service provider financial institution subsystem 350 to appropriately sign certain data to be shared with secure element 145 that may be later unsigned by CASD 158 of secure element 145.

As shown in FIG. 1, for example, service provider financial institution subsystem 350 may be configured to generate, include, or otherwise have access to a service provider private key (“SP-SK”) 355a and a service provider public key (“SP-PK”) 355b, where such keys may be generated or accessed by service provider financial institution subsystem 350. Additionally or alternatively, service provider financial institution subsystem 350 may be configured to sign SP public key 355b with at least a portion of the CASD data provided to service provider financial institution subsystem 350 by commercial entity subsystem 400 as data 578 at step 528. For example, service provider financial institution subsystem 350 may be configured to use ECDSA with at least a portion of the CASD data provided to service provider financial institution subsystem 350 by commercial entity subsystem 400 as data 578 at step 528

CASD-Cert. 158c) for signing SP public key 355b before transmitting that signed SP public key data from on-board service provider financial institution subsystem 350 to a remote entity, such as to commercial entity subsystem 400 as signed SP “Credential Store Data” 580 at step 530, which may then be ISD-encrypted with issuer ISD key(s) 157 and forwarded on to secure element 145 by commercial entity subsystem 400 as encrypted signed data 580 as part of step 530. For example, at least certain portions of service provider financial institution subsystem 350 may be configured to utilize ECDSA or any other suitable algorithm or scheme as a signing algorithm for signing data to be securely transmitted off of service provider financial institution subsystem 350. Store Data 580 may be configured to be transmitted to secure element 145 of device 100 at step 530 for storing or otherwise making SP public key 355b of service provider financial institution subsystem 350 available for use by SSD 154 (e.g., the SPSD to be managed or otherwise controlled by service provider financial institution subsystem 350 for provisioning a commerce credential of service provider financial institution subsystem 350 in that SPSD) or by any other portion of device 100. In particular instances, Store Data 580 may include SP public key 355b and/or any other suitable information.

As mentioned, such a Store Data command 580 may be communicated to device 100 via commercial entity subsystem 400, where such a Store Data command 580 may be encrypted with issuer ISD key(s) 157 by commercial entity subsystem 400, such that the encrypted signed Store Data command 580 may not be accessible by any entity that is not privy to issuer ISD key(s) 157 (e.g., any entity other than ISD 152 and commercial entity subsystem 400). In such embodiments, Store Data command 580 may be provided by commercial entity subsystem 400 to electronic device 100 via communications path 65 of FIG. 1. For example, as shown in FIG. 4, communications component 106 of electronic device 100 may be configured to receive such an encrypted Store Data command 580 from commercial entity subsystem 400 using any suitable communications protocol over any suitable communications path 65, where encrypted Store Data command 580 may be provided to device 100 and then decrypted with issuer ISD key(s) 157 of ISD 152 before being passed on to other portions of secure element 145, such as on to CASD 158 for unsigning a signed Store Data command 580. In some embodiments, service provider financial institution subsystem 350 and SSD 154 may each have a shared secret and secure key(s) that may be leveraged to create a secure channel for commerce credential data (e.g., as requested at step 520) between service provider financial institution subsystem 350 and SSD 154 (e.g., to communicate at least a portion of the commerce credential being provisioned) at step 530. For example, service provider financial institution subsystem 350 may leverage secure key(s) (e.g., SSD secure keys 155s/SP secure keys 355s) to encode, encrypt, wrap, or otherwise sign some or all commerce credential data that is to be provisioned on SSD 154 as credential store data 580 and securely transmit such data 580 to electronic device 100 at step 530. Moreover, service provider financial institution subsystem 350 may sign such secure data 580 with CA information using ECDSA.

Such secure provisioning credential data 580 may include any suitable data, such as, a descriptor of the selected credential to be provisioned, as well as visual artwork and other metadata that may be provided on device 100 for aiding user interaction with the credential once provisioned (e.g., some or all suitable data that may enable device 100 to make the credential visually appear as available to device 100, such as visual logos/icons and other user discernible data associated with the credential that may be provided to the user (e.g., when the specific icon 182 labeled with a “Passbook” textual indicator 181 (i.e., specific icon 184) of FIG. 3 is selected, device 100 may launch or otherwise access a specific passbook or wallet application and may display screens of a specific user interface that may include one or more visual descriptors of the credential), where such data 580 generated and encrypted by service provider financial institution subsystem 350 may be transmitted by financial institution subsystem 350 (e.g., by an appropriate payment network subsystem 360) to commercial entity subsystem 400 (e.g., to an SMP broker of commercial entity subsystem 400) via communications path 55 of FIG. 1 using any suitable communications protocol over any suitable communications path type (e.g., via a TSM of communications path 55) and that data 580 may be forwarded on by commercial entity subsystem 400 to device 100.

In some embodiments, system 1 and/or process 500 may be configured to provision a virtual credential on device 100 rather than the actual credential that may be identified at step 504. For example, once it is determined that a credential is to be provisioned on device 100, it may be requested (e.g., by financial institution subsystem 350, by commercial entity subsystem 400, and/or by a user of device 100) that a virtual credential be generated, linked to the actual credential, and provisioned on device 100 instead of the actual credential. That is, commercial entity subsystem 400 may generate and transmit credential provisioning data 578 to financial institution subsystem 350 at step 528 that may also include a specific instruction for financial institution subsystem 350 to create a new virtual credential (e.g., a device primary account number (“D-PAN”)), link that virtual credential with the selected actual credential (i.e., a funding primary account number (“F-PAN”) originally issued by the issuing bank), and then provision that virtual credential onto device 100. Accordingly, in such embodiments, financial institution subsystem 350 may generate and transmit credential store data 580 at step 530 that may include a descriptor of the virtual credential (e.g., the D-PAN) to be provisioned and any suitable metadata that ought to be provided on device 100 for aiding user interaction with the virtual credential to be provisioned. Such linking or other suitable association of a virtual credential with an actual credential may be performed by any suitable component of financial institution subsystem 350. For example, financial institution subsystem 350 (e.g., a particular payment network subsystem 360 that may be associated with the brand of the actual credential identified at step 520) may define and store an entry in a virtual-linking table or data structure 352 (e.g., as shown in FIG. 1), where such an entry may create an association or link between the actual credential and a virtual credential. Thus, when a virtual credential is utilized by device 100 for a financial transaction with merchant subsystem 200 (e.g., after the virtual credential has been provisioned on device 100), financial institution subsystem 350 may receive an authorization request indicative of that virtual credential and may conduct an analysis of that authorization request in light of the actual credential associated or otherwise linked with the identified virtual credential as determined by virtual-linking table 352. By provisioning a virtual credential on device 100 rather than an actual credential, financial institution subsystem 350 may be configured to limit the fraudulent activity that may result if the virtual credential is intercepted by an unauthorized user (e.g., by an NFC communication 15 signal stealer positioned adjacent device 100 and/or merchant terminal 220), as financial institution subsystem 350 (e.g., payment network subsystem 360) may only be configured to utilize virtual-linking table 352 for linking the virtual credential to the actual credential during certain transactions (e.g., during NFC transactions received by merchant terminal 220 and not during online transactions or other transactions that may allow credential information to be manually entered by a user). Therefore, in such embodiments using a virtual credential, provisioning credential data 584 generated and encrypted by financial institution subsystem 350 may contain a new D-PAN (e.g., new virtual credential information) from an entry in table 352 that may define a link between an F-PAN (e.g., an actual credential banking number) of the selected credential and this new D-PAN. Credential store data 580 may also include the last four digits or any other suitable data of the linked F-PAN for creating a hashed version of the F-PAN. Providing both the virtual D-PAN and a hashed version of the actual F-PAN on device 100 may prevent user confusion between the two and may enable easier user association of the two when utilizing a virtual credential for a financial transaction. Therefore, in some embodiments, a full version of an F-PAN (e.g., an actual credential banking number) may never be stored on device 100, but rather only an associated D-PAN (e.g., a linked virtual credential) may be stored in non-hashed form on device 100. Credential store data 580 may also include a unique D-PAN hash (e.g., the last four digits of the D-PAN and/or any other suitable data for creating a hashed version of the D-PAN that may be used in all subsequent calls to reference this D-PAN while maintaining security of the D-PAN).

Credential store data 580 may also include an “AuthToken” or any other suitable token that may be a one-time use token for enabling provision of the credential. Additionally or alternatively, credential store data 580 may include put pending command data that may include the primary account number (e.g., D-PAN or F-PAN, hashed or not) of the credential being provisioned, one or more persoScripts or GlobalPlatform application protocol data unit (APDU) scripts (e.g., any scripts, any rotate keys (e.g., if necessary), and any other suitable administrative elements that may be used to provision a usable PAN on device 100), an SSD identifier, and/or an SSD counter.

Then, in response to receiving such securely encrypted and signed (e.g., with issuer ISD key(s) 157 by commercial entity subsystem 400) credential store data 580 transmitted at step 530, device 100 (e.g., CASD 158 and/or SSD 154) may appropriately unencrypt data 580 with issuer ISD key(s) 157 and securely load data 580 into SSD 154 (e.g., into applet 153 as applet data 153d) at step 532. If data 580 was signed by service provider financial entity subsystem 350, CASD 158 may confirm that data 580 was properly signed and then unsign such data 580 before providing it to SSD 154. Then, also at step 532, SSD 154 (e.g., SSD key module 155) may leverage SSD secure keys 155s local to secure element 145 to decode, decrypt, or otherwise unwrap the credential data of data 580 that had been encoded, encrypted, and/or otherwise wrapped by service provider financial entity subsystem 350 (e.g., at step 530 using SP secure keys 355s). Then, also at step 532, secure element 145 (e.g., SSD key module 155) may load that decoded, decrypted, or otherwise unwrapped credential data of data 584 into an appropriate portion of SSD 154 (e.g., into applet module 153 as applet data 153d). When data 580 is loaded into SSD 154 at step 532, device 100 may be configured to complete any of the received scripts from data 580 and/or take any other suitable action for enabling the credential (e.g., for toggling the credential from a disabled/pending activation state to an enabled/active for use state). Then, any suitable confirmation data 584 may be generated and transmitted by device 100 at step 534 for alerting commercial entity subsystem 400 and/or service provider financial entity subsystem 350 that the commerce credential has been successfully provisioned on secure element 145, such that the provisioned commerce credential may be used in a commercial transaction as described herein with respect to subsystems 200 and 300 of FIG. 1.

Therefore, process 500 may provide for the rotating or replacing of vendor ISD key(s) 156 with issuer ISD key(s) 157 to prevent secure element vendor subsystem 450 from being able to potentially create a secure communication channel with ISD 152 when secure element 100 is provided on device 100 for an end user. Such issuer ISD key(s) 157 may be known and used by commercial entity subsystem 400 for creating a secure communication channel with secure element 145 for any suitable purpose, such as provisioning a credential on SSD 154.

It is understood that the steps shown in process 500 of FIG. 5 are merely illustrative and that existing steps may be modified or omitted, additional steps may be added, and the order of certain steps may be altered. It is also to be understood that certain steps of process 500 (e.g., steps 502-504) may occur when at least a portion of secure element 145 (e.g., ISD 152) is local to or otherwise under the control of secure element vendor subsystem 450, while other steps of process 500 (e.g., steps 512-518) may occur when at least a portion of secure element 145 (e.g., ISD 152) is local to or otherwise under the control of commercial entity subsystem 400 (e.g., when secure element 145 is being provisioned into electronic device 100 during the manufacturing of device 100), and/or while other steps of process 500 (e.g., steps 520-534) may occur when secure element 145 is local to or otherwise under the control of an end user of electronic device 100 (e.g., when device 100 with secure element 145 is being used by an end user to provision a credential on secure element 145 and/or use such a provisioned credential during a commercial transaction). Secure element 145 may be a highly secure, tamper-resistant hardware component within a chip, which may be used for storing sensitive data or applications on electronic device 100. At least a portion of secure element 145 may be provided in a removable circuit card, such as a universal integrated circuit card (“UICC”) or a subscriber identity module (“SIM”) card, that may be used in electronic devices 100 compatible within global system for mobile communications (“GSM”) networks, universal mobile telecommunications systems (“UMTS”) and/or long-term evolution (“LTE”) standard networks. Alternatively or additionally, at least a portion of secure element 145 may be provided in an integrated circuit that may be embedded into electronic device 100 during manufacturing of device 100. Alternatively or additionally, at least a portion of secure element 145 may be provided in a peripheral device that can be plugged into, inserted into, or otherwise coupled to electronic device 100, such as a micro secure digital (“SD”) memory card.

### Description of FIG. 6

FIG. 6 is a flowchart of an illustrative process 600. At step 602, process 600 may store a first key in an issuer security domain of a secure element of an electronic device. For example, as described above with respect to FIGS. 1-5, device 100 may be configured to store vendor ISD key 156 in ISD 152 of secure element 145. Next, at step 604, process 600 may receive issuer data at the secure element from a commercial entity subsystem. For example, as described above with respect to FIGS. 1-5, device 100 may be configured to receive vendor-issuer data 556 at secure element 145 from commercial entity subsystem 400. Next, at step 606, process 600 may decrypt the received issuer data with the stored first key at the secure element. For example, as described above with respect to FIGS. 1-5, device 100 may be configured to decrypt received vendor-issuer data 556 at secure element 145 with stored vendor ISD key 156. Next, at step 608, process 600 may store a second key in the issuer security domain based on the decrypted issuer data. For example, as described above with respect to FIGS. 1-5, device 100 may be configured to store issuer ISD key 157 in ISD 152 of secure element 145 based on decrypted vendor-issuer data 556.

It is understood that the steps shown in process 600 of FIG. 6 are merely illustrative and that existing steps may be modified or omitted, additional steps may be added, and the order of certain steps may be altered.

### Further Description of FIG. 1

As mentioned, merchant terminal 220 may be provided by any suitable merchant of merchant subsystem 200 that may provide a product or service to a user of device 100 in response to device 100 providing payment credentials via communication 15 to terminal 220. Based on such a received NFC communication 15, merchant subsystem 200 may be configured to generate and transmit data 295 to acquiring bank subsystem 300 (e.g., via a communication path 25 between merchant subsystem 200 and acquiring bank subsystem 300), where data 295 may include payment information and an authorization request that may be indicative of the user's commerce credential and the merchant's purchase price for the product or service. Also known as a payment processor or acquirer, acquiring bank subsystem 300 may be a banking partner of the merchant associated with merchant subsystem 200, and acquiring bank subsystem 300 may be configured to work with financial institution subsystem 350 to approve and settle credential transactions attempted by electronic device 100 via NFC communication 15 with merchant subsystem 200. Acquiring bank subsystem 300 may then forward the authorization request from data 295 to financial institution subsystem 350 as data 395 (e.g., via a communication path 35 between acquiring bank subsystem 300 and financial institution subsystem 350). One, some, or all components of acquiring bank subsystem 300 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

As mentioned, payment network subsystem 360 and issuing bank subsystem 370 may be a single entity or separate entities. For example, American Express may be both a payment network subsystem 360 and an issuing bank subsystem 370. In contrast, Visa and MasterCard may be payment network subsystems 360, and may work in cooperation with issuing bank subsystems 370, such as Chase, Wells Fargo, Bank of America, and the like. In the case of payment network subsystem 360 and issuing bank subsystem 370 being separate entities, payment network subsystem 360 may receive the authorization request of data 395 from acquiring bank subsystem 300 and may then forward the request to issuing bank subsystem 370 as data 495 (e.g., via a communication path 45 between payment network subsystem 360 and issuing bank subsystem 370). In the case of payment network subsystem 360 and issuing bank subsystem 370 being the same entity, acquiring bank subsystem 300 may submit the authorization request of data 395 directly to issuing bank subsystem 370. Furthermore, payment network subsystem 360 may respond to acquiring bank subsystem 300 on behalf of issuing bank subsystem 370 (e.g., according to conditions agreed upon between payment network subsystem 360 and issuing bank subsystem 370). By interfacing between acquiring bank subsystem 300 and issuing bank subsystem 370, payment network subsystem 360 may reduce the number of entities that each acquiring bank subsystem 300 and each issuing bank subsystem 370 may have to interact with directly. That is, to minimize direct integration points of financial institution subsystem 350, payment network subsystem 360 may act as an aggregator for various issuing banks 370 and/or various acquiring banks 300. Financial institution subsystem 350 may also include one or more acquiring banks, such as acquiring bank subsystem 300. For example, acquiring bank subsystem 300 may be the same entity as issuing bank subsystem 370. One, some, or all components of payment network subsystem 360 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of issuing bank subsystem 370 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

When issuing bank subsystem 370 receives an authorization request (e.g., directly from acquiring bank subsystem 300 as data 395 or indirectly via payment network subsystem 360 as data 495), the payment information (e.g., commerce credential information of device 100) and the purchase amount included in the authorization request may be analyzed to determine if the account associated with the commerce credential has enough credit to cover the purchase amount. If sufficient funds are not present, issuing bank subsystem 370 may decline the requested transaction by transmitting a negative authorization response 499 to acquiring bank subsystem 300 (i.e., as response 399 via payment network subsystem 360). However, if sufficient funds are present, issuing bank subsystem 370 may approve the requested transaction by transmitting a positive authorization response 499/399 to acquiring bank subsystem 300 and the financial transaction may be completed, while notification of the authorization response may be forwarded on to merchant subsystem 200 from acquiring bank subsystem 300 as data 299. Either type of authorization response may be provided by user financial subsystem 350 to acquiring bank subsystem 300 as authorization response data 399 (e.g., authorization response data 399 may be provided directly from issuing bank subsystem 370 to acquiring bank subsystem 300 via communication path 35, or authorization response data 399 may be provided from payment network subsystem 360 to acquiring bank subsystem 300 based on authorization response data 499 that may be provided to payment network subsystem 360 from issuing bank subsystem 370 via communication path 45).

As mentioned, although not shown, commercial entity subsystem 400 of FIG. 1 may be a secure platform system and may include a secure mobile platform (“SMP”) broker component, an SMP trusted services manager (“TSM”) component, an SMP crypto services component, an identity management system (“IDMS”) component, a fraud system component, a hardware security module (“HSM”) component, and/or a store component. One, some, or all components of commercial entity subsystem 400 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of commercial entity subsystem 400 may be managed by, owned by, at least partially controlled by, and/or otherwise provided by a single commercial entity (e.g., Apple Inc.) that may be distinct and independent from financial institution subsystem 350. The components of commercial entity subsystem 400 may interact with each other and collectively with both financial institution subsystem 350 and electronic device 100 for providing a new layer of security and/or for providing a more seamless user experience when it is being determined whether or not to provision a credential from financial institution subsystem 350 on to device 100.

An SMP broker component of commercial entity subsystem 400 may be configured to manage user authentication with a commercial entity user account. Such an SMP broker component may also be configured to manage the life cycle and provisioning of credentials on device 100. An SMP broker component may be a primary end point that may control the user interface elements (e.g., elements of GUI 180) on device 100. An operating system or other application of device 100 (e.g., application 103, application 113, and/or application 143) may be configured to call specific application programming interfaces (“APIs”) and an SMP broker component may be configured to process requests of those APIs and respond with data that may derive the user interface of device 100 and/or respond with application protocol data units (“APDUs”) that may communicate with secure element 145 of NFC component 120 (e.g., via a communication path 65 between commercial entity subsystem 400 and electronic device 100). Such APDUs may be received by commercial entity subsystem 400 from financial institution subsystem 350 via a trusted services manager (“TSM”) of system 1 (e.g., a TSM of a communication path 55 between commercial entity subsystem 400 and financial institution subsystem 350). An SMP TSM component of commercial entity subsystem 400 may be configured to provide GlobalPlatform-based services that may be used to carry out credential provisioning operations on device 100 from financial institution subsystem 350. GlobalPlatform, or any other suitable secure channel protocol, may enable such an SMP TSM component to properly communicate and/or provision sensitive account data between secure element 145 of device 100 and a TSM for secure data communication between commercial entity subsystem 400 and financial institution subsystem 350.

An SMP TSM component of commercial entity subsystem 400 may be configured to use an HSM component of commercial entity subsystem 400 to protect its keys and generate new keys. An SMP crypto services component of commercial entity subsystem 400 may be configured to provide key management and cryptography operations that may be required for user authentication and/or confidential data transmission between various components of system 1. Such an SMP crypto services component may utilize an HSM component of commercial entity subsystem 400 for secure key storage and/or opaque cryptographic operations. A payment crypto service of an SMP crypto services component of commercial entity subsystem 400 may be configured to interact with an IDMS component of commercial entity subsystem 400 to retrieve on-file credit cards or other types of commerce credentials associated with user accounts of the commercial entity. Such a payment crypto service may be configured to be the only component of commercial entity subsystem 400 that may have clear text (i.e., non-hashed) information describing commerce credentials (e.g., credit card numbers) of its user accounts in memory. A commercial entity fraud system component of commercial entity subsystem 400 may be configured to run a commercial entity fraud check on a commerce credential based on data known to the commercial entity about the commerce credential and/or the user (e.g., based on data (e.g., commerce credential information) associated with a user account with the commercial entity and/or any other suitable data that may be under the control of the commercial entity and/or any other suitable data that may not be under the control of financial institution subsystem 350). Such a commercial entity fraud system component of commercial entity subsystem 400 may be configured to determine a commercial entity fraud score for the credential based on various factors or thresholds. Additionally or alternatively, commercial entity subsystem 400 may include a store component, which may be a provider of various services to users of device 100 (e.g., the iTunes™ Store for selling/renting media to be played by device 100, the Apple App Store™ for selling/renting applications for use on device 100, the Apple iCloud™ Service for storing data from device 100, the Apple Online Store for buying various Apple products online, etc.). As just one example, such a store component of commercial entity subsystem 400 may be configured to manage and provide an application 113 to device 100 (e.g., via communications path 65), where application 113 may be any suitable application, such as a banking application, an e-mail application, a text messaging application, an internet application, or any other suitable application. Any suitable communication protocol or combination of communication protocols may be used by commercial entity subsystem 400 to communicate data amongst the various components of commercial entity subsystem 400 and/or to communicate data between commercial entity subsystem 400 and other components of system 1 (e.g., financial institution subsystem 350 via communications path 55 of FIG. 1 and/or electronic device 100 via communications path 65 of FIG. 1).

### Further Description of FIG. 2, FIG. 3, and FIG. 4

As mentioned, and as shown in FIG. 2, electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, or any combination thereof. In some embodiments, electronic device 100 may perform a single function (e.g., a device dedicated to conducting financial transactions) and, in other embodiments, electronic device 100 may perform multiple functions (e.g., a device that conducts financial transactions, plays music, and receives and transmits telephone calls). Electronic device 100 may be any portable, mobile, hand-held, or miniature electronic device that may be configured to conduct financial transactions wherever a user travels. Some miniature electronic devices may have a form factor that is smaller than that of hand-held electronic devices, such as an iPod™. Illustrative miniature electronic devices can be integrated into various objects that may include, but are not limited to, watches, rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include a processor 102, memory 104, communications component 106, power supply 108, input component 110, output component 112, antenna 116, and near field communication (“NFC”) component 120. Electronic device 100 may also include a bus 118 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 2. For example, electronic device 100 may include any other suitable components or several instances of the components shown in FIG. 2. For the sake of simplicity, only one of each of the components is shown in FIG. 2.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated on one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications component 106 may be provided to allow device 100 to communicate with one or more other electronic devices or servers or subsystems (e.g., one or more subsystems or other components of system 1) using any suitable communications protocol. For example, communications component 106 may support Wi-Fi (e.g., an 802.11 protocol), ZigBee (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 106 may also include or be electrically coupled to any suitable transceiver circuitry (e.g., transceiver circuitry or antenna 116 via bus 118) that can enable device 100 to be communicatively coupled to another device (e.g., a host computer or an accessory device) and communicate with that other device wirelessly, or via a wired connection (e.g., using a connector port). Communications component 106 may be configured to determine a geographical position of electronic device 100. For example, communications component 106 may utilize the global positioning system (“GPS”) or a regional or site-wide positioning system that may use cell tower positioning technology or Wi-Fi technology.

Power supply 108 can include any suitable circuitry for receiving and/or generating power, and for providing such power to one or more of the other components of electronic device 100. For example, power supply 108 can be coupled to a power grid (e.g., when device 100 is not acting as a portable device or when a battery of the device is being charged at an electrical outlet with power generated by an electrical power plant). As another example, power supply 108 can be configured to generate power from a natural source (e.g., solar power using solar cells). As another example, power supply 108 can include one or more batteries for providing power (e.g., when device 100 is acting as a portable device). For example, power supply 108 can include one or more of a battery (e.g., a gel, nickel metal hydride, nickel cadmium, nickel hydrogen, lead acid, or lithium-ion battery), an uninterruptible or continuous power supply (“UPS” or “CPS”), and circuitry for processing power received from a power generation source (e.g., power generated by an electrical power plant and delivered to the user via an electrical socket or otherwise). The power can be provided by power supply 108 as alternating current or direct current, and may be processed to transform power or limit received power to particular characteristics. For example, the power can be transformed to or from direct current, and constrained to one or more values of average power, effective power, peak power, energy per pulse, voltage, current (e.g., measured in amperes), or any other characteristic of received power. Power supply 108 can be operative to request or provide particular amounts of power at different times, for example, based on the needs or requirements of electronic device 100 or periphery devices that may be coupled to electronic device 100 (e.g., to request more power when charging a battery than when the battery is already charged).

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, scanner (e.g., a bar code scanner or any other suitable scanner that may obtain product identifying information from a code, such as a bar code, a QR code, or the like), proximity sensor, light detector, motion sensor, biometric sensor (e.g., a fingerprint reader or other feature recognition sensor, which may operate in conjunction with a feature-processing application that may be accessible to electronic device 100 for authenticating a user), and combinations thereof. Each input component 110 can be configured to provide one or more dedicated control functions for making selections or issuing commands associated with operating device 100.

Electronic device 100 may also include one or more output components 112 that may present information (e.g., graphical, audible, and/or tactile information) to a user of device 100. For example, output component 112 of electronic device 100 may take various forms, including, but not limited to, audio speakers, headphones, audio line-outs, visual displays, antennas, infrared ports, haptic output components (e.g., rumblers, vibrators, etc.), or combinations thereof.

As a specific example, electronic device 100 may include a display output component as output component 112. Such a display output component may include any suitable type of display or interface for presenting visual data to a user. A display output component may include a display embedded in device 100 or coupled to device 100 (e.g., a removable display). A display output component may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof. Alternatively, a display output component can include a movable display or a projecting system for providing a display of content on a surface remote from electronic device 100, such as, for example, a video projector, a head-up display, or a three-dimensional (e.g., holographic) display. As another example, a display output component may include a digital or mechanical viewfinder, such as a viewfinder of the type found in compact digital cameras, reflex cameras, or any other suitable still or video camera. A display output component may include display driver circuitry, circuitry for driving display drivers, or both, and such a display output component can be operative to display content (e.g., media playback information, application screens for applications implemented on electronic device 100, information regarding ongoing communications operations, information regarding incoming communications requests, device operation screens, etc.) that may be under the direction of processor 102.

It should be noted that one or more input components and one or more output components may sometimes be referred to collectively herein as an input/output (“I/O”) component or I/O interface (e.g., input component 110 and output component 112 as I/O component or I/O interface 114). For example, input component 110 and output component 112 may sometimes be a single I/O component 114, such as a touch screen, that may receive input information through a user's touch of a display screen and that may also provide visual information to a user via that same display screen.

Processor 102 of electronic device 100 may include any processing circuitry that may be operative to control the operations and performance of one or more components of electronic device 100. For example, processor 102 may receive input signals from input component 110 and/or drive output signals through output component 112. As shown in FIG. 2, processor 102 may be used to run one or more applications, such as an application 103, an application 113, and/or an application 143. Each application 103/113/143 may include, but is not limited to, one or more operating system applications, firmware applications, media playback applications, media editing applications, NFC low power mode applications, biometric feature-processing applications, cryptography applications, or any other suitable applications. For example, processor 102 may load application 103/113/143 as a user interface program to determine how instructions or data received via an input component 110 or other component of device 100 may manipulate the way in which information may be stored and/or provided to the user via an output component 112. Application 103/113/143 may be accessed by processor 102 from any suitable source, such as from memory 104 (e.g., via bus 118) or from another device or server (e.g., via communications component 106). Processor 102 may include a single processor or multiple processors. For example, processor 102 may include at least one “general purpose” microprocessor, a combination of general and special purpose microprocessors, instruction set processors, graphics processors, video processors, and/or related chips sets, and/or special purpose microprocessors. Processor 102 also may include on board memory for caching purposes.

Electronic device 100 may also include near field communication (“NFC”) component 120. NFC component 120 may be any suitable proximity-based communication mechanism that may enable contactless proximity-based transactions or communications 15 between electronic device 100 and merchant subsystem 200 (e.g., a merchant payment terminal). NFC component 120 may allow for close range communication at relatively low data rates (e.g., 424 kbps), and may comply with any suitable standards, such as ISO/IEC 7816, ISO/IEC 18092, ECMA-340, ISO/IEC 21481, ECMA-352, ISO 14443, and/or ISO 15593. Alternatively or additionally, NFC component 120 may allow for close range communication at relatively high data rates (e.g., 370 Mbps), and may comply with any suitable standards, such as the TransferJet™ protocol. Communication between NFC component 120 and merchant subsystem 200 may occur within any suitable close range distance between device 100 and merchant subsystem 200 (see, e.g., distance D of FIG. 1), such as a range of approximately 2 to 4 centimeters, and may operate at any suitable frequency (e.g., 13.56 MHz). For example, such close range communication of NFC component 120 may take place via magnetic field induction, which may allow NFC component 120 to communicate with other NFC devices and/or to retrieve information from tags having radio frequency identification (“RFID”) circuitry. NFC component 120 may provide a manner of acquiring merchandise information, transferring payment information, and otherwise communicating with an external device (e.g., terminal 220 of merchant subsystem 200).

NFC component 120 may include any suitable modules for enabling contactless proximity-based communication 15 between electronic device 100 and merchant subsystem 200. As shown in FIG. 2, for example, NFC component 120 may include an NFC device module 130, an NFC controller module 140, and an NFC memory module 150.

NFC device module 130 may include an NFC data module 132, an NFC antenna 134, and an NFC booster 136. NFC data module 132 may be configured to contain, route, or otherwise provide any suitable data that may be transmitted by NFC component 120 to merchant subsystem 200 as part of a contactless proximity-based or NFC communication 15. Additionally or alternatively, NFC data module 132 may be configured to contain, route, or otherwise receive any suitable data that may be received by NFC component 120 from merchant subsystem 200 as part of a contactless proximity-based communication 15.

NFC transceiver or NFC antenna 134 may be any suitable antenna or other suitable transceiver circuitry that may generally enable communication of communication 15 from NFC data module 132 to merchant subsystem 200 and/or to NFC data module 132 from subsystem 200. Therefore, NFC antenna 134 (e.g., a loop antenna) may be provided specifically for enabling the contactless proximity-based communication capabilities of NFC component 120.

Alternatively or additionally, NFC component 120 may utilize the same transceiver circuitry or antenna (e.g., antenna 116) that another communication component of electronic device 100 (e.g., communication component 106) may utilize. For example, communication component 106 may leverage antenna 116 to enable Wi-Fi, Bluetooth™, cellular, or GPS communication between electronic device 100 and another remote entity, while NFC component 120 may leverage antenna 116 to enable contactless proximity-based or NFC communication 15 between NFC data module 132 of NFC device module 130 and another entity (e.g., merchant subsystem 200). In such embodiments, NFC device module 130 may include NFC booster 136, which may be configured to provide appropriate signal amplification for data of NFC component 120 (e.g., data within NFC data module 132) so that such data may be appropriately transmitted by shared antenna 116 as communication 15 to subsystem 200. For example, shared antenna 116 may require amplification from booster 136 before antenna 116 (e.g., a non-loop antenna) may be properly enabled for communicating contactless proximity-based or NFC communication 15 between electronic device 100 and merchant subsystem 200 (e.g., more power may be needed to transmit NFC data using antenna 116 than may be needed to transmit other types of data using antenna 116).

NFC controller module 140 may include at least one NFC processor module 142. NFC processor module 142 may operate in conjunction with NFC device module 130 to enable, activate, allow, and/or otherwise control NFC component 120 for communicating NFC communication 15 between electronic device 100 and merchant subsystem 200. NFC processor module 142 may exist as a separate component, may be integrated into another chipset, or may be integrated with processor 102, for example, as part of a system on a chip (“SoC”). As shown in FIG. 2, NFC processor module 142 of NFC controller module 140 may be used to run one or more applications, such as an NFC low power mode or wallet application 143 that may help dictate the function of NFC component 120. Application 143 may include, but is not limited to, one or more operating system applications, firmware applications, NFC low power applications, wallet applications, cryptography applications, or any other suitable applications that may be accessible to NFC component 120 (e.g., application 103/113). NFC controller module 140 may include one or more protocols, such as the Near Field Communication Interface and Protocols (“NFCIP-1”), for communicating with another NFC device (e.g., merchant subsystem 200). The protocols may be used to adapt the communication speed and to designate one of the connected devices as the initiator device that controls the near field communication.

NFC controller module 140 may control the near field communication mode of NFC component 120. For example, NFC processor module 142 may be configured to switch NFC device module 130 between a reader/writer mode for reading information (e.g., communication 15) from NFC tags (e.g., from merchant subsystem 200) to NFC data module 132, a peer-to-peer mode for exchanging data (e.g., communication 15) with another NFC enabled device (e.g., merchant subsystem 200), and a card emulation mode for allowing another NFC enabled device (e.g., merchant subsystem 200) to read information (e.g., communication 15) from NFC data module 132. NFC controller module 140 also may be configured to switch NFC component 120 between active and passive modes. For example, NFC processor module 142 may be configured to switch NFC device module 130 (e.g., in conjunction with NFC antenna 134 or shared antenna 116) between an active mode where NFC device module 130 may generate its own RF field and a passive mode where NFC device module 130 may use load modulation to transfer data to another device generating an RF field (e.g., merchant subsystem 200). Operation in such a passive mode may prolong the battery life of electronic device 100 compared to operation in such an active mode. The modes of NFC device module 130 may be controlled based on preferences of a user and/or based on preferences of a manufacturer of device 100, which may be defined or otherwise dictated by an application running on device 100 (e.g., application 103 and/or application 113 and/or application 143).

NFC memory module 150 may operate in conjunction with NFC device module 130 and/or NFC controller module 140 to allow for NFC communication 15 between electronic device 100 and merchant subsystem 200. NFC memory module 150 may be embedded within NFC device hardware or within an NFC integrated circuit (“IC”). NFC memory module 150 may be tamper resistant and may provide at least a portion of secure element 145. For example, NFC memory module 150 may store one or more applications relating to NFC communications (e.g., application 143) that may be accessed by NFC controller module 140. For example, such applications may include financial payment applications, secure access system applications, loyalty card applications, and other applications, which may be encrypted. In some embodiments, NFC controller module 140 and NFC memory module 150 may independently or in combination provide a dedicated microprocessor system that may contain an operating system, memory, application environment, and security protocols intended to be used to store and execute sensitive applications on electronic device 100. NFC controller module 140 and NFC memory module 150 may independently or in combination provide at least a portion of secure element 145, which may be tamper resistant. For example, such a secure element 145 may be configured to provide a tamper-resistant platform (e.g., as a single- or multiple-chip secure microcontroller) that may be capable of securely hosting applications and their confidential and cryptographic data in accordance with rules and security requirements that may be set forth by a set of well-identified trusted authorities (e.g., an authority of financial institution subsystem and/or an industry standard, such as GlobalPlatform). Secure element 145 may be a highly secure, tamper-resistant hardware component within a chip, which may be used for storing sensitive data or applications on electronic device 100. At least a portion of secure element 145 may be provided in a removable circuit card, such as a universal integrated circuit card (“UICC”) or a subscriber identity module (“SIM”) card, that may be used in electronic devices 100 compatible within global system for mobile communications (“GSM”) networks, universal mobile telecommunications systems (“UMTS”) and/or long-term evolution (“LTE”) standard networks. Alternatively or additionally, at least a portion of secure element 145 may be provided in an integrated circuit that may be embedded into electronic device 100 during manufacturing of device 100. Alternatively or additionally, at least a portion of secure element 145 may be provided in a peripheral device that can be plugged into, inserted into, or otherwise coupled to electronic device 100, such as a micro secure digital (“SD”) memory card. NFC memory module 150 may be a portion of memory 106 or at least one dedicated chip specific to NFC component 120. NFC memory module 150 may reside on a SIM, a dedicated chip on a motherboard of electronic device 100, or as an external plug in memory card. NFC memory module 150 may be completely independent from NFC controller module 140 and may be provided by different components of device 100 and/or provided to electronic device 100 by different removable subsystems.

As shown in FIGS. 2 and 4, NFC memory module 150 may include one or more of an issuer security domain (“ISD”) 152 and a supplemental security domain (“SSD”) 154 (e.g., a service provider security domain (“SPSD”), a trusted service manager security domain (“TSMSD”), etc.), and CASD 158, one or more of which may be defined and managed by an NFC specification standard (e.g., GlobalPlatform). For example, ISD 152 may be a portion of NFC memory module 150 in which a trusted service manager (“TSM”) or issuing financial institution (e.g., commercial entity subsystem 400 and/or financial institution subsystem 350) may store keys and/or other suitable information for creating or otherwise provisioning one or more credentials (e.g., commerce credentials associated with various credit cards, bank cards, gift cards, access cards, transit passes, digital currency (e.g., bitcoin and associated payment networks), etc.) on electronic device 100 (e.g., via communications component 106), for credential content management, and/or for security domain management. A specific supplemental security domain (“SSD”) 154 may be associated with a particular TSM and at least one specific commerce credential (e.g., a specific credit card credential or a specific public transit card credential) that may provide specific privileges or payment rights to electronic device 100. For example, a first payment network subsystem 360 (e.g., Visa) may be the TSM for a first SSD 154 and different applets 153 of that first SSD 154 may be associated with different commerce credentials managed by that first payment network subsystem 360, while a second payment network subsystem 360 (e.g., MasterCard) may be the TSM for a second SSD 154 and different applets 153 of that second SSD 154 may be associated with different commerce credentials managed by that second payment network subsystem 360, where one credential applet of an SSD can be deleted while another credential applet of that same SSD may be maintained. Alternatively, each credential applet 153 may be provided by its own SSD 154.

Security features may be provided for enabling use of NFC component 120 (e.g., for enabling activation of commerce credentials provisioned on device 100) that may be particularly useful when transmitting confidential payment information, such as credit card information or bank account information of a credential, from electronic device 100 to merchant subsystem 200 as NFC communication 15. Such security features also may include a secure storage area that may have restricted access. For example, user authentication via personal identification number (“PIN”) entry or via user interaction with a biometric sensor may need to be provided to access the secure storage area (e.g., for a user to alter a life cycle state of a security domain element of secure element 145). In certain embodiments, some or all of the security features may be stored within NFC memory module 150. Further, security information, such as an authentication key, for communicating with subsystem 200 may be stored within NFC memory module 150. In certain embodiments, NFC memory module 150 may include a microcontroller embedded within electronic device 100.

While NFC component 120 has been described with respect to near field communication, it is to be understood that component 120 may be configured to provide any suitable contactless proximity-based mobile payment or any other suitable type of contactless proximity-based communication 15 between electronic device 100 and merchant subsystem 200. For example, NFC component 120 may be configured to provide any suitable short-range communication, such as those involving electromagnetic/electrostatic coupling technologies.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

As mentioned, and as shown in FIG. 3, one specific example of electronic device 100 may be a handheld electronic device, such as an iPhone™, where housing 101 may allow access to various input components 110a-110i, various output components 112a-112c, and various I/O components 114a-114d through which device 100 and a user and/or an ambient environment may interface with each other. Input component 110a may include a button that, when pressed, may cause a “home” screen or menu of a currently running application to be displayed by device 100. Input component 110b may be a button for toggling electronic device 100 between a sleep mode and a wake mode or between any other suitable modes. Input component 110c may include a two-position slider that may disable one or more output components 112 in certain modes of electronic device 100. Input components 110d and 110e may include buttons for increasing and decreasing the volume output or any other characteristic output of an output component 112 of electronic device 100. Each one of input components 110a-110e may be a mechanical input component, such as a button supported by a dome switch, a sliding switch, a control pad, a key, a knob, a scroll wheel, or any other suitable form.

An output component 112a may be a display that can be used to display a visual or graphic user interface (“GUI”) 180, which may allow a user to interact with electronic device 100. GUI 180 may include various layers, windows, screens, templates, elements, menus, and/or other components of a currently running application (e.g., application 103 and/or application 113 and/or application 143) that may be displayed in all or some of the areas of display output component 112a. For example, as shown in FIG. 3, GUI 180 may be configured to display a first screen 190. One or more of user input components 110a-110i may be used to navigate through GUI 180. For example, one user input component 110 may include a scroll wheel that may allow a user to select one or more graphical elements or icons 182 of GUI 180. Icons 182 may also be selected via a touch screen I/O component 114a that may include display output component 112a and an associated touch input component 110f. Such a touch screen I/O component 114a may employ any suitable type of touch screen input technology, such as, but not limited to, resistive, capacitive, infrared, surface acoustic wave, electromagnetic, or near field imaging. Furthermore, touch screen I/O component 114a may employ single point or multi-point (e.g., multi-touch) input sensing.

Icons 182 may represent various layers, windows, screens, templates, elements, and/or other components that may be displayed in some or all of the areas of display component 112a upon selection by the user. Furthermore, selection of a specific icon 182 may lead to a hierarchical navigation process. For example, selection of a specific icon 182 may lead to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. For example, when the specific icon 182 labeled with a “Setup Assistant” textual indicator 181 (i.e., specific icon 183) is selected, device 100 may launch or otherwise access a specific setup application and may display screens of a specific user interface that may include one or more tools or features for interacting with device 100 in a specific manner. For each application, screens may be displayed on display output component 112a and may include various user interface elements. Additionally or alternatively, for each application, various other types of non-visual information may be provided to a user via various other output components 112 of device 100. The operations described with respect to various GUIs 180 may be achieved with a wide variety of graphical elements and visual schemes. Therefore, the described embodiments are not intended to be limited to the precise user interface conventions adopted herein. Rather, embodiments may include a wide variety of user interface styles.

Electronic device 100 also may include various other I/O components 114 that may allow for communication between device 100 and other devices. I/O component 114b may be a connection port that may be configured for transmitting and receiving data files, such as media files or customer order files, from a remote data source and/or power from an external power source. For example, I/O component 114b may be a proprietary port, such as a Lightning™ connector or a 30-pin dock connector from Apple Inc. of Cupertino, Calif. I/O component 114c may be a connection slot for receiving a SIM card or any other type of removable component. I/O component 114d may be a headphone jack for connecting audio headphones that may or may not include a microphone component. Electronic device 100 may also include at least one audio input component 110g, such as a microphone, and at least one audio output component 112b, such as an audio speaker.

Electronic device 100 may also include at least one haptic or tactile output component 112c (e.g., a rumbler), a camera and/or scanner input component 110h (e.g., a video or still camera, and/or a bar code scanner or any other suitable scanner that may obtain product identifying information from a code, such as a bar code, a QR code, or the like), and a biometric input component 110i (e.g., a fingerprint reader or other feature recognition sensor, which may operate in conjunction with a feature-processing application that may be accessible to electronic device 100 for authenticating a user). As shown in FIG. 3, at least a portion of biometric input component 110i may be incorporated into or otherwise combined with input component 110a or any other suitable input component 110 of device 100. For example, biometric input component 110i may be a fingerprint reader that may be configured to scan the fingerprint of a user's finger as the user interacts with mechanical input component 110a by pressing input component 110a with that finger. As another example, biometric input component 110i may be a fingerprint reader that may be combined with touch input component 110f of touch screen I/O component 114a, such that biometric input component 110i may be configured to scan the fingerprint of a user's finger as the user interacts with touch screen input component 110f by pressing or sliding along touch screen input component 110f with that finger. Moreover, as mentioned, electronic device 100 may further include NFC component 120, which may be communicatively accessible to subsystem 200 via antenna 116 and/or antenna 134 (not shown in FIG. 3). NFC component 120 may be located at least partially within housing 101, and a mark or symbol 121 can be provided on the exterior of housing 101 that may identify the general location of one or more of the antennas associated with NFC component 120 (e.g., the general location of antenna 116 and/or antenna 134).

Moreover, one, some, or all of the processes described with respect to FIGS. 1-6 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 and/or memory module 150 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol (e.g., the computer-readable medium may be communicated to electronic device 100 via communications component 106 (e.g., as at least a portion of an application 103 and/or as at least a portion of an application 113 and/or as at least a portion of an application 143)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are merely illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of an application 103 and/or as at least a portion of an application 113 and/or as at least a portion of an application 143)). For example, any or each module of NFC component 120 may be implemented using any suitable technologies (e.g., as one or more integrated circuit devices), and different modules may or may not be identical in structure, capabilities, and operation. Any or all of the modules or other components of system 1 may be mounted on an expansion card, mounted directly on a system motherboard, or integrated into a system chipset component (e.g., into a “north bridge” chip).

Any or each module or component of system 1 (e.g., any or each module of NFC component 120) may be a dedicated system implemented using one or more expansion cards adapted for various bus standards. For example, all of the modules may be mounted on different interconnected expansion cards or all of the modules may be mounted on one expansion card. With respect to NFC component 120, by way of example only, the modules of NFC component 120 may interface with a motherboard or processor 102 of device 100 through an expansion slot (e.g., a peripheral component interconnect (“PCI”) slot or a PCI express slot). Alternatively, NFC component 120 need not be removable but may include one or more dedicated modules that may include memory (e.g., RAM) dedicated to the utilization of the module. In other embodiments, NFC component 120 may be integrated into device 100. For example, a module of NFC component 120 may utilize a portion of device memory 104 of device 100. Any or each module or component of system 1 (e.g., any or each module of NFC component 120) may include its own processing circuitry and/or memory. Alternatively, any or each module or component of system 1 (e.g., any or each module of NFC component 120) may share processing circuitry and/or memory with any other module of NFC component 120 and/or processor 102 and/or memory 104 of device 100.

As mentioned, electronic device 100 may drive a display (e.g., display output component 112a) with graphical data to display a graphical user interface (“GUI”) 180. GUI 180 may be configured to receive touch input via a touch input component 110f. Embodied as a touch screen (e.g., with display output component 112a as I/O component 114a), touch I/O component 110f may display GUI 180. Alternatively, GUI 180 may be displayed on a display (e.g., display output component 112a) separate from touch input component 110f. GUI 180 may include graphical elements displayed at particular locations within the interface. Graphical elements may include, but are not limited to, a variety of displayed virtual input devices, including virtual scroll wheels, a virtual keyboard, virtual knobs, virtual buttons, any virtual user interface (“UI”), and the like. A user may perform gestures at one or more particular locations on touch input component 110f, which may be associated with the graphical elements of GUI 180. In other embodiments, the user may perform gestures at one or more locations that are independent of the locations of graphical elements of GUI 180. Gestures performed on a touch input component 110 may directly or indirectly manipulate, control, modify, move, actuate, initiate, or generally affect graphical elements, such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad may generally provide indirect interaction. Gestures may also affect non-displayed GUI elements (e.g., causing user interfaces to appear) or may affect other actions of device 100 (e.g., affect a state or mode of a GUI, application, or operating system). Gestures may or may not be performed on a touch input component 110 in conjunction with a displayed cursor. For instance, in the case in which gestures are performed on a touchpad, a cursor or pointer may be displayed on a display screen or touch screen and the cursor or pointer may be controlled via touch input on the touchpad to interact with graphical objects on the display screen. In other embodiments, in which gestures are performed directly on a touch screen, a user may interact directly with objects on the touch screen, with or without a cursor or pointer being displayed on the touch screen. Feedback may be provided to the user via bus 118 in response to or based on the touch or near touches on a touch input component 110. Feedback may be transmitted optically, mechanically, electrically, olfactory, acoustically, or the like or any combination thereof and in a variable or non-variable manner.

### Further Applications of Described Concepts

While there have been described systems, methods, and computer-readable media for rotating keys of an ISD on an electronic device, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method comprising:
storing a first key in an issuer security domain of an electronic device;
establishing a first secure communication path between the issuer security domain and a commercial entity subsystem using the first key;
receiving issuer data from the commercial entity subsystem at the issuer security domain via the first secure communication path; and
storing a second key in the issuer security domain in response to the received issuer data.

2. The method of claim 1, wherein the first key was generated by a secure element vendor subsystem.

3. The method of claim 2, wherein the second key is not accessible to the secure element vendor subsystem.

4. The method of claim 2, further comprising receiving a public key of the commercial entity subsystem from the secure element vendor subsystem.

5. The method of claim 1, further comprising receiving a public key of the commercial entity subsystem from the commercial entity subsystem at the issuer security domain via the first secure communication path.

6. The method of claim 1, further comprising:
receiving a public key of the commercial entity subsystem at the issuer security domain;
establishing a second secure communication path between the issuer security domain and the commercial entity subsystem using the public key; and
communicating the second key from the electronic device to the commercial entity subsystem via the second secure communication path.

7. The method of claim 1, further comprising communicating the second key from the electronic device to the commercial entity subsystem via the first secure communication path.

8. The method of claim 1, wherein the storing the second key comprises replacing the stored first key with the second key in the issuer security domain.

9. The method of claim 1 further comprising:
establishing a second secure communication path between the issuer security domain and the commercial entity subsystem using the second key; and
communicating information between the electronic device and the commercial entity subsystem via the second secure communication path.

10. The method of claim 1, further comprising, prior to the storing the second key, generating the second key using one of the following models:
a Rivest-Shamir-Adleman (“RSA”) pull model;
an elliptic curve cryptography (“ECC”) pull model; and
an elliptic curve cryptography (“ECC”) push model.

11. The method of claim 1, further comprising, prior to the storing the second key, generating the second key on board the electronic device.

12. The method of claim 1, wherein the second key is only accessible to the issuer security domain and the commercial entity subsystem.

13. An electronic device in communication with a commercial entity subsystem, the electronic device comprising:
a communications component that receives encrypted issuer data from the commercial entity subsystem; and
a secure element that:
decrypts the encrypted issuer data with a first key that is stored in an issuer security domain of the secure element; and
stores a second key in the issuer security domain based on the decrypted issuer data.

14. The electronic device of claim 13, wherein the secure element replaces the stored first key with the second key in the issuer security domain.

15. The electronic device of claim 13, wherein the secure element generates the second key using one of the following models:
a Rivest-Shamir-Adleman (“RSA”) pull model;
an elliptic curve cryptography (“ECC”) pull model; and
an elliptic curve cryptography (“ECC”) push model.

16. The electronic device of claim 13, wherein the secure element generates the second key on board the electronic device.

17. The electronic device of claim 13, wherein:
the communications component receives a public key of the commercial entity subsystem; and
the secure element generates the second key using the public key.

18. The electronic device of claim 13, wherein:
the secure element encrypts the second key using the first key; and
the communications component transmits the encrypted second key to the commercial entity subsystem.

19. The electronic device of claim 13, wherein:
the communications component receives a public key of the commercial entity subsystem;
the secure element encrypts the second key using the public key; and
the communications component transmits the encrypted second key to the commercial entity subsystem.

20. The electronic device of claim 13, wherein:
the communications component receives encrypted additional issuer data from the commercial entity subsystem; and
the secure element decrypts the encrypted additional issuer data with the second key that is stored in the issuer security domain.

21. A method comprising:
storing a first key in an issuer security domain of a secure element of an electronic device;
receiving issuer data at the secure element from a commercial entity subsystem;
decrypting the received issuer data with the stored first key at the secure element; and
storing a second key in the issuer security domain based on the decrypted issuer data.

22. The method of claim 21, further comprising, deleting the stored first key from the issuer security domain.

23. The method of claim 21, further comprising sharing the second key from the secure element with the commercial entity subsystem.

24. The method of claim 23, further comprising:
receiving additional issuer data from the commercial entity subsystem at the secure element; and
decrypting the received additional issuer data with the stored second key at the secure element.

25. The method of claim 21, further comprising, before the storing the first key, receiving the first key at the issuer security domain from a secure element vendor subsystem.

26. The method of claim 25, wherein the second key is not accessible by the secure element vendor subsystem.

27. A commercial entity system in communication with an electronic device, the commercial entity system comprising:
at least one processor component;
at least one memory component; and
at least one communications component, wherein the commercial entity system:
encrypts issuer data with a first key;
communicates the encrypted issuer data to an issuer security domain of the electronic device for generating a second key at the electronic device.

28. The commercial entity system of claim 27, wherein the commercial entity system:
receives the second key from the electronic device;
encrypts additional issuer data with the second key; and
communicates the encrypted additional issuer data to the issuer security domain of the electronic device.

29. The commercial entity system of claim 28, wherein the additional issuer data comprises commerce credential data.

30. A non-transitory computer-readable medium comprising computer-readable instructions recorded thereon for:
storing a first key in an issuer security domain of a secure element of an electronic device;
decrypting issuer data with the stored first key at the secure element; and
storing a second key in the issuer security domain based on the decrypted issuer data.
